(19) United States
(12) Patent Application Publication
(10) Pub. No.: US 2026/0182491 A1
(43) Pub. Date: Jul. 2, 2026

(54) IDENTIFICATION, COUNTING, AND DISEASE DETECTION USING ARTIFICIAL INTELLIGENCE FOR AUTOMATED FOOD PRODUCT HARVESTING

(71) Applicants: James Michael Bergman, Oslo, MN (US); Theodore Harold Booth, Twin Valley, MN (US); Chad Joseph Langseth, Oslo, MN (US); Richard Joseph Nelson, Oslo, MN (US); Lane Matthew Odenbach, Grand Forks, ND (US); David Michael Paschke, East Grand Forks, MN (US); Lillian Ruth Steffan, Warren, MN (US); Phillip Harold Steffan, Warren, MN (US)

(72) Inventors: James Michael Bergman, Oslo, MN (US); Theodore Harold Booth, Twin Valley, MN (US); Chad Joseph Langseth, Oslo, MN (US); Richard Joseph Nelson, Oslo, MN (US); Lane Matthew Odenbach, Grand Forks, ND (US); David Michael Paschke, East Grand Forks, MN (US); Lillian Ruth Steffan, Warren, MN (US); Phillip Harold Steffan, Warren, MN (US)

(21) Appl. No.: 19/436,066

(22) Filed: Dec. 30, 2025

Related U.S. Application Data
(60) Provisional application No. 63/740,139, filed on Dec. 30, 2024.

(51) Int. Cl. A01D 33/08; A01D 23/00; A01D 33/00; A01D 33/10; G01G 11/00; G06T 7/00; G06V 10/774; G06V 10/776; G06V 20/59; G06V 20/68

(52) U.S. Cl. CPC A01D 33/08; A01D 23/00; A01D 33/10; G01G 11/003; G06T 7/0002; G06V 10/774; G06V 10/776; G06V 20/59; G06V 20/68; A01D 2033/005; G06T 2207/20081; G06T 2207/30188; G06T 2207/30242; G06T 2207/30268

(57) ABSTRACT

A machine for harvesting root crops integrates imaging devices, machine learning, and automated sorting capabilities to enable real-time crop identification, counting, disease detection, and data collection during harvesting operations. The machine captures images of individual root crops as they are extracted from soil and processes the images using a trained machine learning model to identify individual crops, generate accurate counts, and detect disease conditions based on visual characteristics. A global positioning system determines geographic locations for each identified crop, while weight sensors measure individual crop weights. A controller automatically activates a sorting mechanism to physically separate diseased crops from healthy crops based on disease detection results. The system generates comprehensive crop data records associating each harvested crop with count data, weight data, disease status, and GPS coordinates, creating spatially-referenced maps that correlate crop characteristics with field locations to enable precision agricultural analysis and targeted interventions.

### RELATED APPLICATIONS

This application claims the benefit of priority under 35 U.S.C. § 119(e) to U.S. Provisional Patent Application No. 63/740,139, filed Dec. 30, 2024, entitled “IDENTIFICATION, COUNTING, AND DISEASE DETECTION USING ARTIFICIAL INTELLIGENCE FOR AUTOMATED FOOD PRODUCT HARVESTING,” which is incorporated herein by reference in its entirety.

### TECHNICAL FIELD

The present disclosure relates generally to automated agricultural harvesting systems and methods, and more particularly to intelligent harvesting systems that integrate machine learning-based computer vision, multi-sensor weight measurement, GPS location tracking, and real-time data processing to identify, count, weigh, and characterize individual root crops during harvesting operations. The disclosed technology employs pre-trained machine learning models to process image data captured during harvest for automated crop identification, counting, visual size classification, and disease detection, combines signals from multiple load sensors positioned at different locations within a harvesting machine to calculate predicted weights for individual crops, correlates each harvested crop with precise GPS coordinates indicating its origin location in the field, and generates comprehensive data records for individual crops that enable spatial analysis of yield patterns, crop characteristics, and disease distribution. While described primarily in the context of sugar beet harvesting, the disclosed systems and methods are applicable to various root crops and other mechanically harvested agricultural products transported along conveyor systems during harvest operations.

### BACKGROUND

In the agricultural sector, particularly in the root crop industry, there exists a need for more efficient and accurate methods of harvesting and data collection. Traditional methods involve the use of outdated machinery and manual processes, which are time-consuming and prone to errors. The current systems often rely on manual counting and weighing of root crops, which can lead to inaccuracies and inefficiencies in data collection and analysis. Recent advancements in technology have introduced the potential for integrating advanced computational techniques into agricultural practices. These technologies can automate the identification, counting, and sorting of crops, thereby increasing the precision and speed of data collection. However, existing solutions have not fully leveraged these advancements to address the specific needs of the root crop industry. There remains a gap in the market for a comprehensive system that combines real-time data collection, GPS tracking, and advanced image recognition to enhance the efficiency and accuracy of root crop harvesting and analysis.

### BRIEF DESCRIPTION OF THE SEVERAL VIEWS OF THE DRAWINGS

The present disclosure will be apparent from the following more particular description of examples of embodiments of the technology, as illustrated in the accompanying drawings. The drawings are not necessarily to scale, emphasis instead being placed upon illustrating embodiments of the present disclosure. In the drawings, like numerals may describe similar components in different views. Like numerals having different letter suffixes may represent different instances of similar components. Various ones of the appended drawings merely illustrate example embodiments of the present disclosure and should not be considered as limiting its scope.

FIG. 1 is a flowchart illustrating a method for harvesting and analyzing sugar beets including real-time weighing, GPS tagging, image capture, identification and counting, disease detection, automated sorting, data integration, and data storage operations, consistent with one embodiment.

FIG. 2 is a block diagram illustrating a machine-learning pipeline including data collection and preprocessing, feature engineering, model selection and training, model evaluation, prediction, validation and refinement, and deployment phases, consistent with some embodiments.

FIG. 3 is a data flow diagram illustrating training and use of a machine-learning program including features, training data, machine-learning program training, a trained machine-learning program with neural network, query data processing, and prediction/inference data generation, consistent with some embodiments.

FIG. 4 is a data flow diagram illustrating content generation with generative artificial intelligence including a prompt template, user data, prompt generator, GAI prompt, generative AI model with optional fine-tuning, generated item, and optional content post-processing, consistent with some embodiments.

FIG. 5 is an image illustrating a sugar beet harvesting machine deployed in a field during harvesting operations, consistent with one embodiment.

FIG. 6 is an image illustrating conveyor system components and associated pneumatic or hydraulic connections integrated within a sugar beet harvesting machine, consistent with one embodiment.

FIG. 7 illustrates platform design considerations for a harvesting system including safety, function, serviceability, and simplicity design principles, consistent with one embodiment.

FIG. 8 is an image illustrating mechanical components and conveyor systems of a sugar beet harvesting machine, consistent with one embodiment.

FIG. 9 is a table illustrating timing data from a harvest simulation operation including bagging, bag tying, ticket insertion, and empty bag loading operations with time measurements and calculated averages, consistent with one embodiment.

FIG. 10 is a wiring diagram illustrating electrical connections for multiple load cells integrated into a harvesting system showing color-coded wire connections for load cell one, load cell two, load cell three, and load cell four, consistent with one embodiment.

FIG. 11 is a presentation slide illustrating features of a test plot sugar beet harvester including clean sample mechanisms, data gathering capabilities, safety features, transport capabilities, ease of use features, standard parts, and labor reduction benefits, consistent with one embodiment.

FIG. 12 is an image illustrating a field map generated from test plot harvesting data showing spatial distribution of crop characteristics across harvested test plots, consistent with one embodiment.

FIG. 13 is an image illustrating a yield map overview displaying geographic zones with associated numerical values and percentage distributions representing aggregate crop characteristics within each zone, consistent with one embodiment.

FIG. 14 is an image illustrating a new rear plate and shielding components integrated into a sugar beet harvesting machine, consistent with one embodiment.

FIG. 15 is a screenshot illustrating a machine learning-based sugar beet counter program interface displaying model performance metrics including mean average precision of 99.2%, precision of 100.0%, and recall of 94.0%, along with real-time object detection results on test video, consistent with some embodiments.

FIG. 16 is a block diagram illustrating a computer system architecture including processors, memory components, machine storage medium, input/output components, and communication components configured to execute instructions for implementing the disclosed harvesting and data collection methods, consistent with some embodiments.

FIG. 17 is an image illustrating a Raspberry Pi 4 Model B single-board computer serving as a beet counter camera and computing platform for real-time image processing and machine learning inference operations during harvesting, consistent with one embodiment.

FIG. 18 is a screenshot illustrating programming development environment and software tools used for implementing beet counter algorithms and machine learning models on the edge computing platform, consistent with one embodiment.

FIG. 19 is a video frame illustrating real-time video capture from a camera system integrated into the harvester displaying frame rate performance of 29.99 frames per second during operation, consistent with one embodiment.

FIG. 20 is an image illustrating a test field of approximately 20 acres planted with sugar beets for testing and validation of the automated harvesting system, consistent with one embodiment.

FIG. 21 is a video frame or screenshot illustrating real-time machine learning-based beet detection with frame rate performance of 22.64 frames per second and a detection confidence score of 0.97 during harvesting operations, consistent with one embodiment.

FIG. 22 is a video frame or screenshot illustrating real-time beet identification with the machine learning model detecting a beet with 79% confidence during image processing operations, consistent with one embodiment.

FIG. 23 is a video frame illustrating real-time video capture and processing performance at 29.94 frames per second from the camera system integrated into the harvester during operation, consistent with one embodiment.

FIG. 24 is a screenshot illustrating detailed machine learning detection output showing multiple identified beets with associated confidence scores displayed in a software interface during real-time processing, consistent with one embodiment.

FIG. 25 is a screenshot illustrating machine learning model training progress showing detection results with confidence scores and annotations indicating areas where the camera system requires additional training data to improve discrimination between sugar beets and non-beet objects, consistent with one embodiment.

FIG. 26 is an image illustrating a scale head junction box and barcode scanner interface manufactured by Rice Lake featuring a TuffSeal display, numeric keypad, and control buttons for weight measurement and data recording operations, consistent with one embodiment.

FIG. 27 is an image illustrating a scale head device mounted on the sugar beet harvester for real-time weight measurement and data recording during harvesting operations, consistent with one embodiment.

FIG. 28 is an image illustrating the scale head system configured to automatically record weight data when a barcode ticket is scanned, enabling integration of barcode tracking with weight measurements, consistent with one embodiment.

FIG. 29 is a screenshot illustrating data output exported to Microsoft Excel spreadsheet format showing columns for barcode identifiers, multiple gross weight measurements (GROSS1 and GROSS2), and timestamp/date information for harvested samples, consistent with one embodiment.

FIG. 30 is a composite image illustrating training photographs used to teach the machine learning model to identify and ignore non-sugar-beet items such as soil clumps, rocks, and debris during image processing operations, consistent with one embodiment.

FIG. 31 is a screenshot illustrating machine learning model testing results on non-sugar-beet objects showing detection confidence scores of 4% and 2% for items labeled “BBR 1-803191” and “BEET-SUISD,” demonstrating the model's ability to distinguish between sugar beets and other objects, consistent with one embodiment.

FIG. 32 is a screenshot illustrating the beet counter program running on an older recording for testing purposes displaying lower frame rate performance at 21.59 FPS along with programming code, system performance metrics, and GPU utilization data, consistent with one embodiment.

FIG. 33 is a screenshot illustrating the beet counter running on an older recording achieving higher frame rate performance when executed on a hardware accelerator on a laptop computer with associated programming interface and detection output data, consistent with one embodiment.

FIG. 34 is a screenshot illustrating the beet counter running in real-time on the harvester achieving higher frame rate performance from hardware acceleration, with beets passing through the system at approximately eight per second during testing or approximately two per second under actual field harvesting conditions, consistent with one embodiment.

FIG. 35 is an image illustrating wiring installations on a second selection table of the harvester showing electrical connections and cable routing for load sensors and control systems, consistent with one embodiment.

FIG. 36 is a technical diagram and photograph illustrating a six-section hydraulic control valve block mounted to the harvester including port specifications, safety e-stop, and unloading valve configurations, consistent with one embodiment.

FIG. 37 includes two images illustrating harvested sugar beets utilized for gathering training data for training the machine vision system, consistent with one embodiment.

FIG. 38 is an image illustrating real sugar beets being run through the harvester during testing operations to gather training data for programming the camera system and machine learning models, consistent with one embodiment.

FIG. 39 is a screenshot illustrating the sugar beet counter program running in real-time on actual sugar beets during harvesting operations displaying frame rate performance of 29.08 FPS, consistent with one embodiment.

FIG. 40 is an image illustrating the camera setup and mounting configuration used to capture video footage of topped sugar beets during harvesting operations for training and testing purposes, consistent with one embodiment.

FIG. 41 is a table illustrating hydraulic motor specifications for various harvester components including paddle shaft, bed chain, bed cover chain, rear cross chains, grabroll sets, scrub tower components, and pick tables, showing estimated horsepower, rpm, calculated torque, motor types, displacement, maximum horsepower, GPM, calculated PSI, and motor shaft sizes, consistent with one embodiment.

FIG. 42 is an image illustrating a pulse width modulation (PWM) signal displayed on an oscilloscope used to control a coil valve in the harvesting system, consistent with one embodiment.

FIG. 43 is an image illustrating a potentiometer control device used to adjust motor speed for hydraulic motors integrated into the harvesting machine, consistent with one embodiment.

FIG. 44 is an image illustrating a PWM wifi controller device with control buttons including reset and off functions for wireless control of harvester operations, consistent with one embodiment.

FIG. 45 is a screenshot illustrating a mobile device interface displaying a “Harvester Control” application for remote monitoring and control of the harvesting system, consistent with one embodiment.

FIG. 46 is an image illustrating electronic components and circuitry integrated into the control system of the sugar beet harvesting machine, consistent with one embodiment.

FIG. 47 is an image illustrating barcode sample labels or tickets (showing identifier “004-85845” and text “ACS C Grower Sample Grower”) used for tracking harvested sugar beet samples throughout the data collection and analysis workflow, consistent with one embodiment.

FIG. 48 is a video frame illustrating real-time camera footage captured from a camera positioned at the front of the harvester displaying frame rate performance of 28.48 frames per second during harvesting operations, consistent with one embodiment.

### DETAILED DESCRIPTION

The present disclosure relates to systems and methods for automated identification, counting, weighing, and data collection of harvestable food products, particularly root crops such as sugar beets, using artificial intelligence, machine learning, computer vision, and GPS integration during harvesting operations. The disclosed technology addresses significant limitations in conventional harvesting methods by integrating multiple advanced technologies into a comprehensive harvesting system that collects granular, individual-crop-level data in real-time. The system employs one or more cameras with image processing capabilities and pre-trained machine learning models to automatically identify and count individual crops as they pass through the harvester on conveyor systems. The system further incorporates multiple load sensors positioned at different locations within the harvester to obtain weight measurements of crops under different conditions—including dynamic measurements while crops are moving (providing a “dirty signal”) and static measurements while the machine is stopped (providing accurate “gospel” measurements)—and combines these weight signals with visual sizing data from the machine learning models to calculate predicted weights for individual crops through algorithmic proration. Each identified crop is tagged with precise GPS location data indicating where it was extracted from the ground, enabling the creation of comprehensive data records that include weight, size, location, and quality characteristics such as disease status for each harvested unit. The system can detect diseases and quality defects through visual analysis and can trigger automated sorting mechanisms to separate undesirable crops during harvest. The collected data enables generation of high-resolution field maps showing spatial distribution of yield, crop characteristics, and disease patterns across harvested areas. The following detailed description sets forth various embodiments of the disclosed technology, and those skilled in the art will recognize that the embodiments described herein may be practiced with modification and alteration within the spirit and scope of the appended claims. The embodiments described are provided for illustrative purposes and are not exhaustive. Various features described in connection with one embodiment may be combined with features of other embodiments, and some features may be omitted or modified without departing from the scope of the innovative subject matter described and claimed herein. The order of operations described in method embodiments may be altered, with certain operations performed sequentially, in parallel, or in different sequences, provided that the functional objectives of embodiments of the invention are achieved. Accordingly, the scope of the invention is defined by the appended claims rather than by the specific embodiments described herein.

The following discussion describes the technical problems associated with conventional harvesting methods and the technical solutions provided by embodiments of the disclosed invention primarily in the context of sugar beet harvesting operations. Sugar beets serve as a representative example of root crop harvesting challenges due to their widespread commercial cultivation, the critical importance of disease detection and storage quality in sugar beet production, the prevalence of research plot operations requiring precise data collection, and the technical complexities involved in mechanically extracting, cleaning, counting, weighing, and characterizing individual root crops during high-speed harvesting operations. However, those skilled in the art will recognize that the principles, systems, and methods disclosed herein are not limited to sugar beets and can be readily adapted for use with other root crops and harvestable food products, including but not limited to potatoes, carrots, turnips, radishes, parsnips, rutabagas, onions, garlic, and other vegetables, fruits, or agricultural products that are mechanically harvested using equipment that transports the harvested products along conveyor systems. The fundamental technical challenges of automated identification, counting, weighing, disease detection, GPS location tracking, and data collection during harvesting operations are common across many crop types, and the disclosed technology provides adaptable solutions applicable to diverse agricultural contexts. Accordingly, while sugar beets are used as the primary example throughout this disclosure for clarity and specificity, other embodiments may be configured for harvesting and analyzing various types of harvestable food products.

In the agricultural sector, particularly in sugar beet and root crop production, conventional harvesting methods have relied on a combination of mechanical harvesting equipment and manual data collection processes that date back several decades. Traditional sugar beet harvesters mechanically extract the beets from the ground, separate soil and debris through cleaning mechanisms, and transport the harvested crop via conveyor systems into collection bins or trucks. Data collection regarding yield, quality, and crop characteristics has historically been performed through manual sampling, hand counting, and batch weighing techniques. For example, in research plot harvesting operations involving thousands of test plots, workers manually count individual beets—often numbering in the hundreds of thousands per harvest season—and weigh samples in bulk using bucket weighing systems. This manual approach provides only aggregate data at the plot level, with no information about individual crop characteristics, spatial distribution patterns within plots, or real-time feedback during the harvesting operation itself.

An intermediate technological advancement introduced yield monitoring systems that integrated load cells with GPS positioning technology to create yield maps showing productivity variations across large production fields. These systems measure the total weight of crop flowing over a load sensor while simultaneously recording GPS coordinates, then generate color-coded field maps indicating relative yield levels in different zones. While this technology represented progress for large-scale commodity crop production spanning acres or sections of land, it suffers from significant technical limitations when applied to precision research harvesting or small-scale operations. The load cell measurements provide what practitioners term a “dirty signal”—weight readings contaminated by mechanical vibration, bouncing of crops on conveyors, and dynamic forces from the moving harvester. Furthermore, these systems lack the spatial resolution necessary for research plot applications where individual plots may be only two rows wide and thirty feet long; attempting to apply large-acreage yield monitoring technology to such small plots results in severe “pixelation” of data, rendering the measurements meaningless for plot-level analysis. The systems provide no mechanism for identifying, counting, or characterizing individual crops, and they cannot detect quality defects, diseases, or other visual characteristics that affect crop value.

The technical problems inherent in conventional harvesting methods create multiple operational inefficiencies and data gaps. First, manual counting of individual crops is extraordinarily labor-intensive, time-consuming, and susceptible to human error, particularly when dealing with hundreds of thousands of individual units. Second, the inability to obtain precise weight measurements for individual crops prevents researchers and growers from understanding the true distribution of crop sizes and weights within a field or plot, limiting agronomic insights about growing conditions, genetics, and management practices. Third, the lack of real-time disease detection during harvest means that diseased crops are commingled with healthy ones, creating storage problems; this is particularly critical in sugar beet production where beets are stored in large piles and frozen for winter processing, and diseased beets that store poorly can compromise the quality of entire storage piles. Fourth, existing load cell-based measurement systems cannot isolate the weight of individual crops from the noise created by mechanical vibration and crop movement, making it technically impossible to obtain accurate per-unit weight data in real-time during active harvesting operations. Fifth, the absence of precise GPS location data tied to individual crops prevents the creation of high-resolution maps showing not just aggregate yield, but the specific location of each harvested unit with its associated characteristics, eliminating the possibility of conducting sophisticated spatial analyses of disease patterns, size distribution, and quality variations.

Additional technical challenges arise from the inability of conventional systems to integrate multiple data streams in real-time to overcome the limitations of individual sensors. For instance, while a load cell might measure total weight and a camera might capture images, prior art systems lack the computational intelligence to synthesize visual data (for sizing and counting), dynamic weight measurements (from crops passing over sensors), and static weight measurements (from stationary crops) into accurate individual crop weight estimates. Similarly, conventional systems provide no technical means to identify specific diseases or quality defects through automated visual analysis, relying instead on human operators observing crops moving past at harvest speeds of several feet per second—a task that is physically impossible to perform accurately and consistently. The technical problem is further compounded by the massive scale of data involved: a single moderate-sized farming operation may harvest tens of millions of individual crops per season, and processing this volume of information requires computational approaches that do not exist in prior art harvesting systems. These fundamental technical limitations prevent growers and researchers from obtaining the granular, crop-level data necessary to optimize agronomic practices, improve crop genetics, enhance storage efficiency, and increase overall productivity in root crop production systems.

The disclosed technology provides a comprehensive harvesting system that integrates multiple advanced technologies to address the fundamental technical limitations of conventional root crop harvesting methods. The system operates by combining real-time computer vision, machine learning-based crop identification and disease detection, multi-sensor weight measurement, precise GPS location tracking, and sophisticated algorithmic data processing to collect granular, individual-crop-level data during active harvesting operations.

At the core of the system is a sugar beet harvesting machine configured to mechanically extract sugar beets from the ground and transport them along a conveyor system integrated throughout the harvester. The harvesting machine is a mobile agricultural machine that may be configured as a self-propelled vehicle with its own motive power system, or alternatively may be configured as a towed implement designed to be pulled behind a self-propelled vehicle such as a tractor or other agricultural prime mover. As beets are pulled from the ground, they first pass through a cleaning mechanism that separates soil and debris from the beets through mechanical agitation and screening processes. This cleaning operation is critical to the subsequent data collection processes, as it removes interfering materials that would otherwise compromise visual analysis and weight measurements.

Consistent with some embodiments, the system employs a dual-camera imaging architecture strategically positioned at two locations within the harvester to capture complementary data about each harvested beet. A first camera is positioned near the intake section of the harvester to capture image data of sugar beets immediately after they are pulled from the ground and before they pass through the cleaning mechanism. This first camera serves multiple technical functions: it enables the system to obtain the most precise GPS location data by capturing beets at the point closest to their extraction from the soil, it provides an opportunity for pre-counting to verify counting accuracy downstream, and it generates additional image data that can be incorporated into weight estimation algorithms to further refine predictions. A second camera is positioned downstream after the sugar beets have passed through the cleaning mechanism and the soil has been separated from the beets. This second camera captures high-resolution image data of cleaned beets as they travel along the conveyor system, providing the primary visual data for identification, counting, size classification, and disease detection operations.

The image data captured by the camera system is processed using a pre-trained machine learning model that has been specifically trained to recognize sugar beets and their visual characteristics. The machine learning model is trained through a comprehensive process that includes collecting training data comprising a plurality of images of both synthetic sugar beets (manufactured replicas used for consistent training data generation) and real sugar beets captured under actual harvesting conditions. The training data is systematically labeled to identify individual sugar beets within images and to mark visual characteristics associated with various conditions. The machine learning algorithm is trained on this labeled dataset to recognize visual features characteristic of sugar beets, to distinguish beets from non-beet objects (such as soil clumps, rocks, plant debris, and harvester components), and to detect visual indicators of disease conditions and quality defects. The model is validated on separate test datasets to ensure accurate real-time performance under dynamic harvesting conditions where beets may be moving at speeds of several feet per second, may be overlapping or touching, may have varying orientations, and may be partially obscured.

The pre-trained machine learning model performs several critical functions during real-time harvesting operations. First, it processes the image data to identify individual sugar beets in the captured images, distinguishing each discrete beet from adjacent beets and from background elements. Second, it generates an accurate count of harvested sugar beets based on the identified individual beets, tracking each beet as it passes through the camera's field of view and implementing logic to prevent double-counting when a beet appears in multiple image frames. Third, the model assigns each individual sugar beet to a weight rank within a predetermined range of weight ranks based on visual characteristics of the sugar beet, such as apparent size, dimensions, volume, and shape. In some embodiments, this weight ranking system operates on a scale from one to ten, where rank one represents the smallest/lightest beets and rank ten represents the largest/heaviest beets, though the system can be configured for finer granularity (such as one to one hundred) as additional training data is accumulated. Fourth, the model analyzes image data to identify sugar beets exhibiting undesirable visual characteristics indicative of disease conditions, including but not limited to phytophthora root rot, black root rot, cercospora leaf spot, Rhizoctonia root and crown rot, Rhizomania, and other pathological or quality conditions such as sprangle (excessive lateral root development) or inadequate root development.

The system implements a sophisticated multi-sensor weighing architecture that overcomes the fundamental technical limitation that individual crops cannot be accurately weighed using conventional load cells during active harvesting operations due to mechanical vibration and dynamic forces. The system incorporates a first load sensor (load cell) associated with a first portion of the conveyor system, typically positioned on a roller or conveyor section where individual beets pass as they move through the harvester. This first load sensor receives beets in motion and generates a first signal indicating a total weight measurement of sugar beets on the first portion of the conveyor system while the beets are moving. Because the beets are bouncing, vibrating, and experiencing dynamic forces from the moving machinery, this first signal constitutes what practitioners term a “dirty signal”—a weight measurement that captures real-time weight data but with significant noise and inaccuracy due to the dynamic measurement conditions. While this dirty signal cannot provide accurate individual beet weights in isolation, it contains valuable information about the relative weight of beets passing over the sensor at any given moment.

Consistent with some embodiments, to overcome the limitations of the dirty signal, the system incorporates a second load sensor associated with a second portion of the conveyor system, typically a larger conveyor section spanning approximately thirty feet in length that accumulates a sample of harvested beets (for example, approximately eighty beets) as they are transported along the conveyor. The system periodically stops operation of the harvesting machine, bringing all mechanical motion to a halt. While the machine is stopped, the second load sensor generates a second signal indicating an accurate total weight of the plurality of sugar beets positioned on the second portion of the conveyor system at rest. Because the beets are stationary and not subject to vibration or dynamic forces, this second signal provides a highly accurate “gospel” weight measurement representing the true weight of all beets on that conveyor section. This gospel weight serves as a reference standard against which all other weight calculations must reconcile.

The system implements a sophisticated three-way proration algorithm that synthesizes data from the machine learning model's visual analysis, the first load sensor's dirty signal, and the second load sensor's gospel weight to calculate accurate predicted weights for each individual sugar beet. The algorithm operates as follows: First, the machine learning model processes image data to assign each individual sugar beet to a weight rank within the predetermined range (such as one through ten) based on visual characteristics. This visual ranking provides relative size information—identifying which beets appear larger or smaller than others—but does not by itself provide absolute weight values. Second, the system receives the first signal from the first load sensor indicating the total weight measurement (dirty signal) while sugar beets are moving along the conveyor. Although noisy, this signal provides real-time weight data correlated temporally with the visual observations. Third, the system calculates an initial predicted weight for each individual sugar beet by prorating the total weight measurement from the first signal among the counted sugar beets based on their respectively assigned weight ranks. In this proration process, sugar beets assigned to higher weight ranks receive a proportionally greater allocation of the total weight than sugar beets assigned to lower weight ranks, with the proportional allocation determined by mathematical algorithms that may weight ranks linearly, exponentially, or according to other distribution functions learned from training data.

The three-way proration algorithm then performs a critical adjustment step to achieve accurate individual beet weights. After calculating initial weight estimates for individual beets using the dirty signal and visual rankings, the system compares the accurate total weight indicated by the second signal (gospel weight) to the sum of the predicted weights of the plurality of sugar beets calculated using the first signal. Any discrepancy between these values indicates that the dirty signal-based calculations require adjustment. The system then adjusts the predicted weight for each individual sugar beet of the plurality proportionally based on the difference between the accurate total weight indicated by the second signal and the sum of the predicted weights. Critically, these adjustments maintain the proportional weight relationships among the sugar beets based on their respective assigned weight ranks—that is, if the visual analysis indicated that beet A appeared twice as large as beet B, that 2:1 ratio is preserved in the adjusted weights—while ensuring that the sum of all adjusted predicted weights equals the accurate total weight indicated by the second signal. This three-way proration approach leverages the strengths of each data source: the visual analysis provides relative sizing information and identification of individual beets, the dirty signal provides real-time weight correlation, and the gospel weight provides an accurate reference standard, yielding individual beet weight predictions that achieve accuracy within approximately a quarter pound.

The system integrates precise GPS location tracking throughout the harvesting process to create a comprehensive spatial record of crop origins. A GPS module integrated into the harvester continuously records precise location data with accuracy to within one inch of actual position. As sugar beets are pulled from the ground, the system captures GPS coordinates at that moment, and through correlation with the camera data (particularly from the first camera positioned near the intake), the system obtains GPS data indicating the precise location where each individual sugar beet was pulled from the ground. The sugar beets are maintained in single-file alignment along the conveyor system (or in some embodiments, multiple parallel single-file lines) to facilitate accurate correlation between GPS coordinates, image data, weight measurements, and individual beet identities. The GPS data is continuously synchronized with the image capture timestamps and weight sensor readings to ensure that each data point can be accurately associated with the correct individual sugar beet.

For each individual sugar beet harvested, the system creates a comprehensive data record that integrates all collected information about that particular beet. Each data record includes: (1) the predicted weight of the individual sugar beet calculated through the three-way proration algorithm; (2) the GPS data indicating the precise location where the individual sugar beet was pulled from the ground, accurate to within one inch; (3) the weight rank assigned to the sugar beet within the predetermined range based on visual characteristics; (4) image data captured of the sugar beet; (5) any detected disease status or undesirable visual characteristics identified by the pre-trained machine learning model, including specific disease classifications and severity assessments; (6) timestamp information indicating when the beet was harvested; and (7) any additional metadata such as field plot identifiers, harvest conditions, or quality metrics. These data records enable sophisticated post-harvest analysis of relationships between sugar beet characteristics and field location, providing insights that were previously impossible to obtain with conventional harvesting methods.

When the machine learning model detects a sugar beet exhibiting undesirable visual characteristics indicative of disease or quality defects, the system can activate an automated sorting mechanism integrated into the sugar beet harvesting machine. In response to detecting such a beet, the sorting mechanism directs that sugar beet to a separate path for disposal or further analysis, physically separating it from healthy beets. The sorting mechanism may employ various technologies including pneumatic diverters, mechanical gates, robotic arms, or other actuation systems capable of selectively redirecting individual beets based on real-time identification. This automated disease sorting capability prevents diseased sugar beets from being commingled with healthy beets during collection and storage, thereby addressing a critical problem in the sugar beet industry: diseased beets store poorly and can compromise the quality of entire storage piles if not removed. By performing this sorting operation in real-time during harvest, the system eliminates the need for manual inspection (which is practically impossible at harvest speeds) and ensures that only high-quality beets enter long-term frozen storage for winter processing.

The comprehensive data records generated for each individual sugar beet enable the creation of sophisticated field mapping and visualization products that provide unprecedented agronomic insights. The system analyzes the data records for a plurality of sugar beets harvested from a field to identify spatial patterns in sugar beet characteristics across the field. The system generates field maps that visually represent the field divided into geographic zones based on GPS data, with each zone corresponding to a specific area of the field. The field maps are displayed with visual indicators representing aggregate characteristics of sugar beets harvested from each geographic zone, where visual indicators may include color coding (such as heat maps showing yield gradients), shading, symbols, numerical values, or other graphical representations that convey information about groupings of sugar beets by weight, size, disease prevalence, quality metrics, or other characteristics within each geographic zone. For example, a field map might use green shading to indicate zones where heavy, healthy beets were harvested, yellow shading for zones with lighter beets or moderate disease presence, and red shading for zones with significant disease problems or poor yield. These visualizations enable growers and researchers to identify field areas with specific yield or quality patterns, to correlate crop performance with soil types, drainage patterns, historical management practices, or other agronomic factors, and to make data-driven decisions about future planting, fertilization, irrigation, and management strategies.

In research applications, where thousands of small test plots (such as 3,400 plots of two rows by thirty feet) are harvested to evaluate different genetic varieties or agronomic treatments, the system provides transformative capabilities. Conventional methods required manual counting of hundreds of thousands of individual beets and bulk weighing of samples, providing only aggregate plot-level data with no information about within-plot variability or individual beet characteristics. The disclosed system automatically counts every individual beet (eliminating the need to manually count 400,000 or more beets per harvest season), provides individual weight data for each beet enabling statistical analysis of weight distributions, maps the precise location of each beet within each plot, and identifies disease presence at the individual plant level. This granular data enables researchers to conduct analyses that were previously impossible, such as identifying the spatial distribution of disease within plots, quantifying the relationship between individual plant size and proximity to plot edges, or detecting subtle differences in within-plot variability between genetic lines.

The technical improvements provided by this system over prior art are substantial and multifaceted. First, the system eliminates the labor-intensive and error-prone manual counting process, replacing hundreds of person-hours of tedious hand-counting with automated real-time counting that achieves higher accuracy. Second, the system provides individual-crop-level weight data rather than merely aggregate weights, enabling statistical analysis of weight distributions and identification of individual outliers. Third, the three-way proration algorithm overcomes the fundamental technical limitation that individual crops cannot be accurately weighed in motion using load cells, synthesizing noisy real-time measurements with accurate static measurements and visual size classifications to calculate reliable individual weights. Fourth, the system provides precise GPS location data for each individual crop harvested, enabling high-resolution field mapping far exceeding the capabilities of conventional yield monitors designed for large-acreage applications. Fifth, the automated disease detection and sorting capabilities enable real-time quality control that is physically impossible for human operators to perform at harvest speeds, preventing diseased crops from compromising storage quality. Sixth, the comprehensive data records created for each individual crop enable sophisticated post-harvest analyses of spatial patterns, disease correlations, and agronomic relationships that provide actionable insights for improving future growing practices and crop genetics. Seventh, the system's modular architecture and machine learning foundation enable continuous improvement as additional training data is accumulated, with the model becoming progressively more accurate in identification, sizing, and disease detection tasks over time and across diverse growing conditions, crop varieties, and operational environments. The system thus transforms sugar beet harvesting from a purely mechanical extraction process into a comprehensive data collection and analysis operation that provides unprecedented insights into crop characteristics, field performance, and quality attributes at the individual plant level.

The following examples illustrate specific embodiments, features, and capabilities of the disclosed harvesting technology that may be implemented individually or in various combinations to achieve the technical objectives of automated crop identification, counting, weighing, characterization, and data collection during harvesting operations. These examples demonstrate how particular technical elements of the system address specific operational requirements and data collection needs in agricultural harvesting contexts. Those skilled in the art will recognize that the features described in these examples may be selectively combined, modified, or adapted based on specific application requirements, crop types, harvesting equipment configurations, and operational objectives. The examples are provided to illustrate the breadth and versatility of the disclosed technology and should not be construed as limiting the scope to only the specific configurations described.

Real-time Weighing and GPS Tagging System—A system that performs real-time weighing of harvested harvestable food products while simultaneously tagging each harvestable food product with GPS location data. This system ensures that each beet's weight and location are recorded accurately during the harvesting process, enabling spatial analysis of yield patterns and crop characteristics across harvested areas.

Automated Harvestable Food Product Sorting Based on Disease Detection—A method for automatically sorting harvestable food products during the harvesting process based on the detection of diseases. The system uses camera sensors and machine learning algorithms to identify diseased harvestable food products and activates sorting mechanisms that direct them to a different path for disposal or further analysis, preventing diseased crops from being commingled with healthy crops during collection and storage.

Barcode and Sample Tracking System—A system that assigns barcodes to individual harvestable food products or batches of harvestable food products and ties these barcodes to specific samples. This system allows for precise tracking and identification of each harvestable food product or sample throughout the harvesting and analysis process. The system implements a comprehensive barcode-based tracking and data collection framework that enables precise identification of individual harvestable food products throughout the harvesting and analysis process. Barcode integration with live ground counting checkpoints provides verification of counting system accuracy by comparing automated counts with barcode-tracked samples. The data collection system incorporates barcode scanning functionality that automatically records and stores multiple data points, including weight measurements, timestamps, date information, and repeated weight readings for each sample. When barcodes are scanned, the system automatically exports the collected data to spreadsheet formats or database systems for further analysis. The barcode system interfaces directly with scale heads and junction boxes, enabling automated weight data recording upon ticket or tag scanning. This integrated approach facilitates comprehensive sample tracking while maintaining data accuracy throughout the harvesting and analysis workflow.

Single-File Harvestable Food Product Processing Mechanism—A mechanism that maintains harvestable food products in a single-file arrangement during the harvesting process. This mechanism helps maintain the order and alignment of harvestable food products as they travel along the conveyor system, facilitating accurate correlation between GPS location data, image capture timestamps, weight measurements, and individual crop identities. Additional embodiments can include multi-file or multi-lane configurations where multiple parallel lines or rows of harvestable food products are processed simultaneously, with the system collecting data associated with each harvestable food product across all multiple lines at the same time. Multi-file data collection can be correlated across any or all of the multiple lines of harvestable food products simultaneously, with algorithms tracking individual crops across parallel processing streams.

Pre-Weighing Harvestable Food Product Sizing System—A system that sizes harvestable food products before they reach weighing mechanisms. This system uses imaging technology and machine learning algorithms to determine the size and estimated weight classification of each harvestable food product, assigning each crop to a weight rank within a predetermined range based on visual characteristics. This visual sizing information is then combined with load sensor data to calculate predicted weights for individual crops through algorithmic proration.

Live Harvestable Food Product Counter Camera System—A camera system that counts harvestable food products in real-time during the harvesting process. This system captures images or video of harvestable food products as they pass through the harvester and uses image processing algorithms and pre-trained machine learning models to count and record the number of harvestable food products accurately, tracking individual crops across multiple image frames and implementing logic to prevent double-counting.

Data Collection and Analysis System—A comprehensive system that collects and analyzes data from the harvesting process, including predicted weight, GPS location, size classification, disease status, and quality characteristics of each individual crop. This system generates data records for each harvested crop and uses machine learning algorithms that improve identification accuracy, sizing precision, and disease detection capabilities over time as additional training data is accumulated from diverse growing conditions, crop varieties, and operational environments.

Integration of Open-Source Software for Harvestable Food Product Identification—A method for integrating open-source machine learning frameworks, computer vision libraries, and software platforms with custom algorithms to identify, count, and characterize harvestable food products during the harvesting process. This method leverages existing software tools such as open-source image processing libraries, machine learning frameworks, and data analysis platforms, and enhances them with proprietary training datasets, custom neural network architectures, and specialized algorithms optimized for real-time agricultural applications to achieve improved performance.

Yield Mapping System—A system that creates detailed yield maps and field visualization products based on the GPS-tagged data of harvested harvestable food products. This system analyzes data records for a plurality of crops to identify spatial patterns, generates field maps that visually represent the field divided into geographic zones, and displays visual indicators such as color coding, shading, or numerical values representing aggregate characteristics of crops harvested from each zone. These maps provide insights into the yield, weight distribution, size patterns, and quality characteristics of harvestable food products across different field areas, test plots, or growing zones.

Infrared Sugar Sampling Technology Integration—A method for integrating infrared spectroscopy or other composition analysis technology with the harvestable food product harvesting system. This method allows for immediate sugar content analysis, solids content measurement, or other compositional assessment of harvestable food products during the harvesting process by incorporating near-infrared (NIR) sensors or other analytical instruments that non-destructively measure chemical composition. The composition data is incorporated into the data records for individual crops, providing comprehensive information linking sugar content, weight, size, disease status, and GPS location for yield and quality assessment.

The disclosed harvesting system integrates multiple technical components and processes that work cooperatively to achieve automated identification, counting, weighing, characterization, and data collection of individual harvestable food products during real-time harvesting operations. The following sections describe the key technical elements of the system architecture and their respective functions within the overall harvesting and data collection framework. These elements may be implemented individually or in various combinations depending on specific application requirements, and the system architecture is designed to enable modular integration of components to address particular operational needs.

Live Weighing System: The system implements a multi-sensor weighing architecture that obtains weight measurements of harvestable food products in real-time during active harvesting operations. A first load sensor associated with a first portion of the conveyor system generates a first signal indicating a total weight of crops while they are moving along the conveyor, providing real-time weight data despite mechanical vibration and dynamic forces. A second load sensor associated with a second portion of the conveyor system generates a second signal indicating an accurate total weight of crops while the harvesting machine is stopped and crops are at rest, providing a reference standard for weight calculations. The system synthesizes these weight measurements with visual sizing data to calculate predicted weights for individual crops through algorithmic proration, achieving individual crop weight accuracy that was previously unattainable with conventional load cell-based systems.

GPS Location Tracking System: The system incorporates a GPS module integrated into the harvesting machine that continuously records precise location data with accuracy to within one inch of actual position. As harvestable food products are pulled from the ground, the system captures GPS coordinates and correlates this location data with image data, weight measurements, and crop identification information to tag each individual harvested crop with GPS data indicating the precise location where that crop was pulled from the ground. This GPS tagging enables comprehensive spatial analysis of yield patterns, crop characteristics, and disease distribution across harvested areas, providing insights that were previously impossible to obtain with conventional harvesting methods.

Barcode and Sample Tracking System: The system implements barcode-based tracking capabilities that assign unique identifiers to individual harvestable food products or batches of crops and tie these barcodes to specific samples throughout the harvesting and analysis process. The barcode system interfaces with data collection hardware including scale heads and junction boxes to automatically record weight measurements, timestamps, and other data points when barcodes are scanned. Barcode integration with live counting checkpoints provides verification of automated counting system accuracy by enabling comparison between machine learning-based counts and barcode-tracked reference samples. The system automatically exports barcode-linked data to database systems or spreadsheet formats for further analysis, facilitating comprehensive sample tracking while maintaining data integrity throughout the workflow.

Camera and Machine Learning Identification System: The system employs one or more cameras positioned at strategic locations within the harvester to capture image data of harvestable food products as they pass through the harvesting machine. The cameras may include high-resolution digital cameras, 3D imaging systems, multispectral or hyperspectral imaging devices, or other optical sensors capable of capturing visual characteristics of crops under dynamic harvesting conditions. The captured image data is processed using pre-trained machine learning models that have been trained on labeled datasets comprising images of both synthetic and real crops to recognize visual features characteristic of the target crops. The machine learning models perform multiple functions including: identifying individual crops in the image data and distinguishing them from non-crop objects, generating accurate counts of harvested crops, assigning each crop to a weight rank within a predetermined range based on visual size characteristics, and detecting visual indicators of disease conditions or quality defects. The machine learning system is trained using supervised learning techniques on platforms that may include open-source frameworks, proprietary training environments, or cloud-based machine learning services, with training datasets continuously expanded to improve performance across diverse growing conditions and crop varieties. The system's capabilities may be adapted for various agricultural applications beyond root crops, including large-scale commodity crops such as wheat, soybeans, corn, and other mechanically harvested agricultural products. The processing architecture supports real-time analysis of multiple crops per second during harvest operations while maintaining accuracy in identification, counting, and characterization tasks.

Disease Detection and Automated Sorting System: The system implements automated disease detection capabilities by training the machine learning models to identify visual characteristics indicative of pathological conditions affecting harvestable food products. For sugar beets, the system is trained to recognize diseases including phytophthora root rot, black root rot, cercospora leaf spot, Rhizoctonia root and crown rot, Rhizomania, and other disease conditions based on visual symptoms observable on harvested crops. When the machine learning model detects a crop exhibiting undesirable visual characteristics indicative of disease or quality defects, the system activates an automated sorting mechanism integrated into the harvesting machine that physically directs the affected crop to a separate path for disposal or further analysis. This real-time sorting capability prevents diseased crops from being commingled with healthy crops during collection and storage, addressing critical storage quality problems where diseased crops can compromise entire storage facilities. The disease detection algorithms can be adapted to identify crop-specific diseases and quality parameters for different agricultural products, and the sorting functionality provides real-time quality control capabilities that are physically impossible for human operators to perform at harvest speeds.

Comprehensive Data Collection and Storage System: The system collects extensive data for each individual harvested crop and generates comprehensive data records that integrate information from multiple sensors and analysis systems. Each data record includes: predicted weight calculated through multi-sensor weight measurement and algorithmic proration, GPS location data indicating the precise field coordinates where the crop was extracted, weight rank or size classification assigned based on visual analysis, captured image data, disease status or quality assessment results from machine learning analysis, timestamp information, and additional metadata such as field identifiers or environmental conditions. The system implements data storage architectures capable of handling large-scale harvesting operations that may generate terabytes of data from hundreds of thousands or millions of individual crops harvested per season. Data integration features combine information from barcode tracking systems, scale measurements, GPS tracking, imaging systems, and machine learning analysis into unified data records. The system supports automatic export of collected data to various formats including spreadsheet files, database systems, or specialized agricultural data management platforms for post-harvest analysis and visualization.

Real-Time Processing and Post-Harvest Analysis Capabilities: The system architecture implements computational processing capabilities that perform real-time analysis during active harvesting operations while also enabling detailed post-harvest review and analysis. During harvest, the system processes image data, generates crop identifications and counts, obtains weight measurements, records GPS coordinates, performs disease detection, and creates data records for individual crops, all in real-time as crops flow through the harvester at speeds of multiple units per second. The processing system handles multiple parallel data streams including high-resolution image capture from one or more cameras, continuous GPS coordinate acquisition, real-time weight measurements from multiple load sensors, and concurrent machine learning inference operations. Post-harvest analysis capabilities enable detailed review of collected data including frame-by-frame examination of captured images, statistical analysis of weight distributions, spatial analysis of yield patterns using GPS-tagged data, and identification of disease prevalence patterns across harvested areas. The system may support multi-file or multi-lane processing configurations where multiple parallel streams of crops are simultaneously analyzed, with algorithms correlating data across all processing streams.

Artificial Intelligence Optimization and Continuous Improvement: The system leverages machine learning architectures that enable continuous improvement in performance as additional data is accumulated over time. The machine learning models improve identification accuracy, sizing precision, counting reliability, and disease detection capabilities through exposure to diverse training data representing different crop varieties, growing conditions, soil types, weather patterns, and operational environments. Training datasets can be expanded by incorporating images and associated ground-truth data (verified counts, measured weights, confirmed disease diagnoses) collected during actual harvesting operations, creating a feedback loop where operational data improves model performance. The system may implement transfer learning techniques where models trained on one crop type or growing region are adapted for application to different crops or locations, reducing the data requirements for deploying the system in new contexts. Machine learning optimization extends beyond the computer vision and identification tasks to encompass the weight calculation algorithms, GPS correlation methods, and data integration processes, with the overall system efficiency and accuracy improving as more operational data is processed. This artificial intelligence-driven continuous improvement capability enables the system to adapt to changing conditions, new crop varieties, emerging disease patterns, and evolving operational requirements without requiring manual reprogramming or reconfiguration.

The disclosed system employs machine learning and computer vision technologies to address fundamental technical challenges in automated crop harvesting that cannot be solved through conventional mechanical or sensor-based approaches alone. The integration of pre-trained machine learning models with real-time image processing enables the system to perform tasks that require visual recognition and classification capabilities analogous to human perception, but at speeds and scales that exceed human capacity. Specifically, the system must identify individual crops moving at harvest speeds of several feet per second, distinguish crops from soil, debris, and harvester components, count individual crops while preventing double-counting across sequential image frames, classify crop sizes based on visual characteristics to assign weight ranks, and detect subtle visual indicators of disease conditions or quality defects. These tasks require the machine learning models to process high-resolution image data in real-time, make classification decisions within milliseconds, and maintain accuracy across widely varying visual conditions including different lighting environments, crop orientations, degrees of soil contamination, and levels of crop overlap or occlusion. The computer vision algorithms must handle the dynamic nature of harvesting operations where crops are moving, bouncing, and rotating as they travel along conveyor systems, creating motion blur and constantly changing perspectives that complicate visual analysis.

Integration of the artificial intelligence components with the physical harvesting machinery and sensor systems presents significant technical challenges that the disclosed system addresses through coordinated data processing and synchronization. The machine learning analysis of image data must be temporally synchronized with GPS location acquisition, load sensor measurements, and conveyor position tracking to ensure that each data point is correctly associated with the corresponding individual crop. The system implements buffering and data correlation algorithms that account for the physical distances and time delays between different sensor positions within the harvester, ensuring that a crop identified by the camera at one location can be correctly matched with its weight measurement obtained at a different location and its GPS coordinates captured at yet another point in the harvesting process. When disease detection triggers an automated sorting mechanism, the system must calculate the precise timing to activate pneumatic diverters or mechanical gates to physically redirect the specific identified crop, requiring coordination between visual identification, crop tracking along the conveyor, and actuator control systems operating within millisecond time scales. The integration architecture must handle multiple parallel data streams from cameras capturing images at high frame rates, GPS modules reporting coordinates continuously, load sensors generating weight readings at specified intervals, and machine learning models producing identification and classification results for multiple crops simultaneously. The system addresses the challenge of deploying computationally intensive machine learning inference operations in the harsh physical environment of agricultural machinery, where computers and sensors must operate reliably despite vibration, dust, temperature variations, and electromagnetic interference from harvesting equipment. By implementing robust hardware architectures, optimized machine learning models capable of real-time inference on edge computing platforms, and comprehensive data validation and error-checking algorithms, the disclosed system achieves reliable integration of artificial intelligence capabilities with mechanical harvesting operations, enabling automated data collection and analysis capabilities that were previously unattainable in agricultural harvesting systems.

Furthermore, the integration of AI systems with existing agricultural machinery and workflows can be complex. Ensuring that these systems are user-friendly and accessible to farmers with varying levels of technical expertise is also essential. It is known from prior art that traditional methods of crop monitoring and yield estimation often rely on manual counting and sampling techniques. These methods can be time-consuming, labor-intensive, and prone to human error. Additionally, they may not provide the level of detail and accuracy required for precision farming. Existing solutions may also lack the ability to process data in real-time, limiting their effectiveness in dynamic agricultural environments. There is thus a need for an advanced system that integrates generative artificial intelligence with interactive interfaces to provide real-time, accurate, and detailed insights into agricultural operations. Such a system should automate data collection and analysis, reduce the reliance on manual processes, and enhance the overall efficiency and productivity of farming practices.

Embodiments of the invention described herein provide several novel aspects that distinguish it from prior art in the field of agricultural technology, particularly in the context of sugar harvestable food product harvesting and analysis. Some of the several novel features of some embodiments of the invention include one or more of the following components:
1. Real-time Weighing and GPS Tagging System: Embodiments integrate real-time weighing of individual harvestable food products with GPS tagging, allowing for precise mapping and tracking of each beet's weight and location during the harvesting process. This combination of real-time data collection and geolocation is not commonly found in existing agricultural systems.
2. Automated Harvestable food product Sorting Based on Disease Detection: The system employs advanced sensors and algorithms to detect and sort out diseased harvestable food products during the harvesting process. This automated disease detection and sorting capability enhances the quality of the harvested crop and reduces the need for manual inspection.
3. Barcode and Sample Tying System: Some embodiments use barcodes to tie each harvestable food product to a specific sample, enabling precise tracking and identification throughout the harvesting and analysis process. This level of granularity in tracking individual harvestable food products is a novel approach in agricultural data management.
4. Single-file Harvestable food product Processing Mechanism: The system ensures that harvestable food products remain in a single file during the harvesting process, facilitating accurate weighing, GPS tagging, and sorting. This mechanism addresses the challenge of maintaining order and alignment of harvestable food products, which is crucial for accurate data collection.
5. On-ground Harvestable food product Sizing System: Some embodiments include a system for sizing harvestable food products on the ground before they are weighed, using imaging technology to determine the size of each beet. This pre-weighing sizing capability adds an additional layer of data for analysis and categorization.
6. Live Harvestable food product Counter Camera System: The system features a camera that counts harvestable food products in real-time during the harvesting process. The use of image processing algorithms to count and record the number of harvestable food products accurately is a novel application of computer vision technology in agriculture.
7. Data Collection and Analysis System: Some embodiments collect and analyze a comprehensive set of data, including weight, size, GPS location, and disease status of each beet. The use of machine learning algorithms to improve accuracy and efficiency over time is a significant advancement in agricultural data analysis.
8. Integration of Open Source Software for Harvestable food product Identification: The system leverages open source software combined with proprietary algorithms to identify and count harvestable food products during the harvesting process. This integration of open source tools with custom enhancements provides a cost-effective and flexible solution for harvestable food product identification.
9. Yield Mapping System: Some embodiments create detailed yield maps based on the GPS-tagged data of harvested harvestable food products. This capability provides valuable insights into the yield and quality of harvestable food products across different test plots, aiding in precision farming practices.
10. Infrared or Similar Chemical Testing and/or Sampling Technology Integration: For example, the system can identify a compositional analysis, such as a chemical composition, of the harvestable food product using artificial intelligence while harvesting the product. For example, the system integrates infrared sugar sampling technology with the harvestable food product harvesting process, allowing for immediate analysis of sugar content. This real-time sugar sampling capability enhances the assessment of yield and quality, providing critical data for decision-making. Examples of the system can further analyze other compositions of the harvestable food product, for example, protein level, water weight, type of harvestable food product (e.g., crop, tuber, fruit, etc.), or other compositional values related to the product. Overall, the novelty of the innovative subject matter set forth herein lies in its comprehensive integration of real-time data collection, advanced imaging and sensing technologies, and machine learning algorithms to enhance the efficiency, accuracy, and quality of harvestable food product harvesting and analysis. These innovative features address the limitations of traditional methods and offer significant improvements in precision farming practices.

The described examples involve a harvestable food product harvester that performs several advanced functions, including live weighing, GPS tagging, and potentially discarding diseased harvestable food products. The system is designed to operate in real-time, providing immediate data on the harvested harvestable food products. The system uses barcoding to tie each harvestable food product to a specific sample. This allows for precise tracking and identification of each harvestable food product throughout the harvesting and analysis process. The barcodes are tied to the samples, ensuring that each beet's data is accurately recorded. One of the challenges addressed by the system is maintaining the order and alignment of the harvestable food products during the harvesting process. The harvestable food products are kept in a single file to ensure accurate GPS location tracking. Multiple single files can be harvested at the same time to create a multi-file collection system. This is achieved by fine-tuning the machine to keep the harvestable food products perfectly in line. The system can also size the harvestable food products on the ground before they reach the scale, using a weighted scale from one to ten. This pre-weighing sizing helps in identifying and categorizing the harvestable food products based on their size. The system includes a live harvestable food product counter camera that captures real-time images of the harvestable food products. The camera system is designed to count the harvestable food products accurately as they move along the conveyor. The data collected by the camera is used to improve the accuracy of the counting process. Examples record data from any amount of harvestable land, for example, 20 acres of harvestable food products, requiring about four terabytes of data storage. The software used in the system improves with more data, becoming smarter and more accurate over time. The system uses open-source components, which are integrated with proprietary algorithms to enhance performance. The system also has potential applications in manufacturing plants, where similar data collection and analysis techniques could be used to improve processes. The described example aims to provide a comprehensive solution for harvestable food product harvesting, integrating advanced technologies for real-time data collection, disease detection, and yield mapping.

In an example, the system performs real-time weighing of harvestable food products during the harvesting process while simultaneously tagging each product with GPS location data. The system can automatically sort diseased products to an alternate path. The system incorporates barcode tracking tied to specific samples for identification purposes. Ground-based counting is enabled through visual markers on select products that serve as counting checkpoints. The GPS tracking system maintains product alignment during transport, with products arranged in a single file or multi-file configuration, for exemplary purposes only, the harvestable food products, such as sugar beets, can be arranged along a 30-foot run containing approximately 80 sugar beets per file. Product alignment precision depends on machine calibration, with optimal tuning allowing for precise linear arrangement. When products reach the conveyor system, minor lateral movement of one to two rows may occur. The system includes pre-scale ground-based sizing capabilities using image processing. Products are assigned relative size values on a weighted scale of one to ten, facilitating product identification and tracking. Real-time or near real-time automated counting is performed using an integrated camera system. The system processes any size farming land, for exemplary purposes only, approximately 20 acres of products were used during testing, requiring four terabytes of data storage for comprehensive analysis, including slow-motion review capabilities.

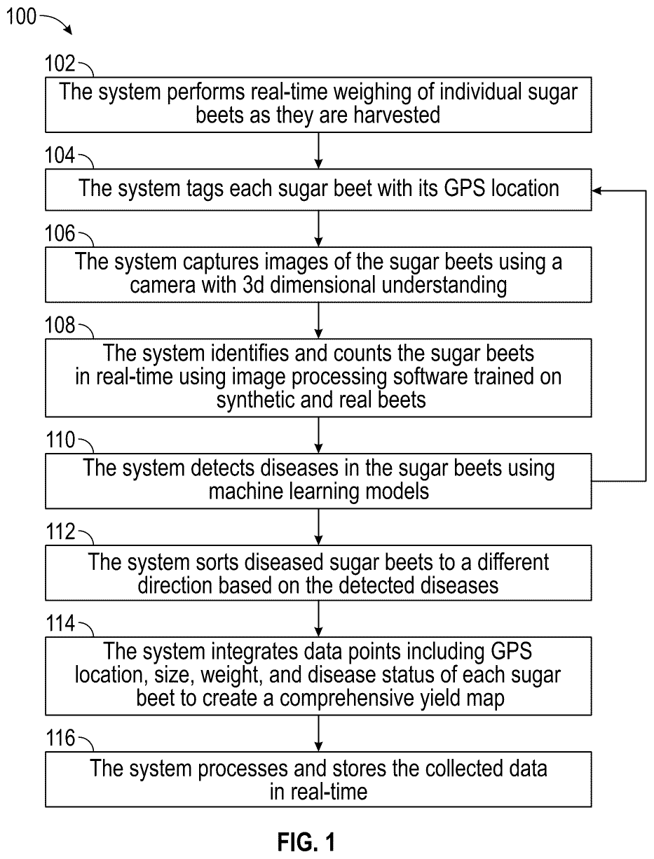

FIG. 1 is a flowchart illustrating a comprehensive method for automated harvesting, identification, counting, weighing, disease detection, and data collection of harvestable food products during real-time harvesting operations, according to embodiments of the disclosed technology. While sugar beets are used as the primary example of harvestable food products throughout this description, those having ordinary skill in the art will understand that the disclosed methods and systems can be adapted for use with other root crops and harvestable food products including potatoes, carrots, turnips, onions, and other mechanically harvested agricultural products that are transported along conveyor systems during harvesting. Although the example method depicted in FIG. 1 shows a particular sequence of operations, the sequence may be altered without departing from the scope of the present disclosure. For example, some of the operations depicted may be performed in parallel or in a different sequence that does not materially affect the function of the method. Different components of the harvester system may perform functions substantially simultaneously, with image capture, GPS data acquisition, weight measurements, and machine learning processing occurring concurrently as crops flow through the harvester in real-time.

At block 102, the system operates a sugar beet harvesting machine configured to pull sugar beets from the ground and transport the sugar beets along a conveyor system integrated throughout the harvester. The harvesting machine may be configured as a self-propelled vehicle or as a towed implement pulled behind a tractor or other prime mover. As the harvester moves through the field, mechanical extraction mechanisms engage with sugar beets in the soil and pull them from the ground. The extracted beets are transferred onto the conveyor system, which may comprise multiple conveyor sections including belts, rollers, chains, or other transport mechanisms that move the beets through various processing stages within the harvester. The conveyor system transports the beets through a cleaning mechanism configured to separate soil and debris from the sugar beets through mechanical agitation, screening, beating, or washing processes. This cleaning operation removes interfering materials that would otherwise compromise subsequent visual analysis and weight measurements, ensuring that the beets presented to cameras and sensors are substantially free of soil contamination.

At block 104, the system captures image data of the sugar beets on the conveyor system using one or more cameras positioned at strategic locations within the harvester. In some embodiments, a first camera is positioned near the intake section to capture image data of sugar beets immediately after they are pulled from the ground and before they pass through the cleaning mechanism, while a second camera is positioned downstream to capture image data after the sugar beets have passed through the cleaning mechanism and soil has been separated from the beets. The cameras may comprise high-resolution digital imaging devices, 3D imaging systems capable of capturing depth information, multispectral or hyperspectral cameras, or other optical sensors suitable for capturing visual characteristics of crops under dynamic harvesting conditions. The cameras capture images at frame rates sufficient to ensure that each individual beet passing through the harvester is captured in at least one image frame, with frame rates typically ranging from 10 to 60 frames per second or higher depending on conveyor speed and harvesting rate. The captured image data includes visual information about the size, shape, color, surface texture, and other observable characteristics of individual sugar beets as they travel along the conveyor system.

At block 106, the system processes the captured image data using a pre-trained machine learning model to identify individual sugar beets in the image data. The pre-trained machine learning model has been trained through a comprehensive process that includes collecting training data comprising images of synthetic sugar beets and real sugar beets, labeling the training data to identify individual sugar beets and their characteristics, training a machine learning algorithm (such as convolutional neural networks, region-based detection models, or other computer vision architectures) on the labeled training data to recognize visual features characteristic of sugar beets, and validating the trained model on separate test datasets to ensure accurate real-time performance. The machine learning model processes each image frame to detect and localize individual sugar beets, distinguishing them from non-beet objects such as soil clumps, rocks, plant debris, and harvester components. The model identifies beet boundaries even when beets are touching or partially overlapping, and tracks individual beets across multiple sequential image frames to maintain consistent identification as beets move through the camera's field of view.

At block 108, the system generates a count of harvested sugar beets based on the identified individual sugar beets. The counting algorithm tracks each identified beet through multiple image frames and implements logic to prevent double-counting when a single beet appears in multiple frames. The system maintains a running count of total beets harvested and may generate separate counts for different categories such as healthy beets versus diseased beets, or beets assigned to different weight ranks. The counting data provides real-time feedback during harvesting operations and eliminates the need for labor-intensive manual counting that would otherwise be required to determine the number of beets harvested.

At block 110, the system processes the image data using the pre-trained machine learning model to assign each individual sugar beet to a weight rank within a predetermined range of weight ranks based on visual characteristics of the beet. The machine learning model analyzes visual features such as apparent size, dimensions, estimated volume, and shape to classify each beet into one of multiple weight categories, for example on a scale from one to ten where rank one represents the smallest/lightest beets and rank ten represents the largest/heaviest beets. This visual size classification provides relative weight information indicating which beets appear larger or smaller than others, though it does not by itself provide absolute weight values. The weight rank assignments are used in subsequent algorithmic calculations to determine predicted weights for individual beets.

At block 112, the system receives a first signal from a first load sensor associated with the conveyor system, wherein the first signal indicates a total weight of sugar beets on a first portion of the conveyor system. The first load sensor comprises a load cell, strain gauge, or other weight measurement device positioned on or integrated with a conveyor section such as a roller, belt, or platform over which beets pass during harvesting. Because the beets are moving and subject to vibration, bouncing, and dynamic forces from the harvester machinery, the first signal constitutes a “dirty signal” that captures real-time weight data but with noise and inaccuracy inherent in dynamic weight measurements. The first signal provides continuous or periodic weight readings indicating the total weight of all beets currently positioned on the first portion of the conveyor at any given moment.

At block 114, the system determines a predicted weight for each individual sugar beet based on the count of harvested sugar beets and the first signal from the load sensor. The system calculates the predicted weight by prorating the total weight measurement from the first signal among the counted sugar beets based on their respective assigned weight ranks, wherein sugar beets assigned to higher weight ranks receive a proportionally greater allocation of the total weight than sugar beets assigned to lower weight ranks. The proration algorithm implements mathematical functions that may weight the ranks linearly, exponentially, or according to other distribution models learned from training data. In some embodiments, the system further refines these predicted weights by periodically stopping the harvester and receiving a second signal from a second load sensor indicating an accurate total weight of beets at rest (a “gospel” weight), comparing this accurate weight to the sum of predicted weights calculated using the first signal, and adjusting the predicted weight for each individual beet proportionally based on the difference while maintaining the proportional weight relationships based on weight ranks. This multi-sensor weight measurement and algorithmic proration approach achieves individual beet weight predictions with accuracy substantially better than would be possible using any single sensor measurement.

At block 116, the system obtains GPS data indicating a precise location where each individual sugar beet was pulled from the ground. A GPS module integrated into the harvester continuously records location coordinates with high precision, for example accurate to within one inch of actual position. The system correlates the GPS coordinates with the timing of beet extraction and the image capture data (particularly from any camera positioned near the intake section) to associate each identified individual beet with the GPS location from which it was harvested. The beets may be maintained in single-file alignment along the conveyor system, or in some embodiments multiple parallel single-file streams, to facilitate accurate correlation between GPS coordinates and individual beet identities as they progress through the harvester.

At block 118, the system detects diseases and undesirable characteristics in the sugar beets using the pre-trained machine learning model. The machine learning model has been trained to identify visual characteristics indicative of disease conditions by training on labeled datasets comprising images of diseased and healthy sugar beets with annotations marking visual symptoms associated with specific pathological conditions. The model analyzes the captured image data to detect visual indicators of diseases including phytophthora root rot, black root rot, cercospora leaf spot, Rhizoctonia root and crown rot, Rhizomania, and other disease conditions or quality defects such as sprangle or inadequate root development. The disease detection analysis generates classification results indicating whether each individual beet exhibits signs of disease and may provide confidence scores or severity assessments for detected conditions.

At block 120, the system activates a sorting mechanism in response to detecting sugar beets exhibiting undesirable visual characteristics. When the machine learning model identifies a diseased or defective beet, the system triggers an automated sorting mechanism integrated into the harvester that directs that specific sugar beet to a separate path for disposal or further analysis. The sorting mechanism may comprise pneumatic diverters, mechanical gates, robotic arms, or other actuation systems positioned along the conveyor that can selectively redirect individual beets. The system calculates precise timing to activate the sorting mechanism based on the beet's position along the conveyor and the physical distance between the camera location and the sorting mechanism location, ensuring that the correct identified beet is diverted. This automated real-time sorting prevents diseased sugar beets from being commingled with healthy beets during collection and storage.

At block 122, the system creates a comprehensive data record for each individual sugar beet harvested. Each data record includes: (1) the predicted weight of the individual sugar beet calculated through the multi-sensor weight measurement and proration algorithm; (2) the GPS data indicating the precise location where the individual sugar beet was pulled from the ground; (3) the weight rank assigned to the sugar beet based on visual characteristics; (4) image data captured of the sugar beet; (5) any detected disease status or undesirable visual characteristics identified by the machine learning model, including specific disease classifications; (6) timestamp information; and (7) additional metadata such as field plot identifiers or environmental conditions. These data records are stored in memory systems including onboard storage devices, removable media, or transmitted to remote servers or cloud-based storage systems for subsequent access and analysis.

At block 124, the system integrates and analyzes the data records to generate field maps and visualization products. The system analyzes data records for a plurality of sugar beets harvested from a field to identify spatial patterns in sugar beet characteristics across the field. The system generates field maps that visually represent the field divided into geographic zones based on GPS data, and displays visual indicators such as color coding, shading, symbols, or numerical values representing aggregate characteristics of sugar beets harvested from each zone. These visual representations may show distributions of beet weights, yield patterns, disease prevalence, or other characteristics, enabling identification of field areas with specific performance patterns. The field maps provide actionable insights for optimizing future agricultural practices including planting decisions, fertilization strategies, irrigation management, and variety selection.

At block 126, the system processes and stores all collected data in real-time during harvesting operations and makes the data available for post-harvest analysis. The data processing capabilities handle multiple parallel data streams including high-resolution image capture from cameras, continuous GPS coordinate acquisition, real-time weight measurements from load sensors, and machine learning inference results, all synchronized and correlated to ensure accurate association of data with individual beets. The stored data can be accessed for various analytical purposes including statistical analysis of weight distributions, spatial analysis of yield patterns, disease pattern identification, research comparisons between test plots or genetic varieties, and long-term trend analysis across multiple harvest seasons. The comprehensive dataset enables insights and optimizations that were previously impossible to achieve with conventional manual counting and bulk weighing methods

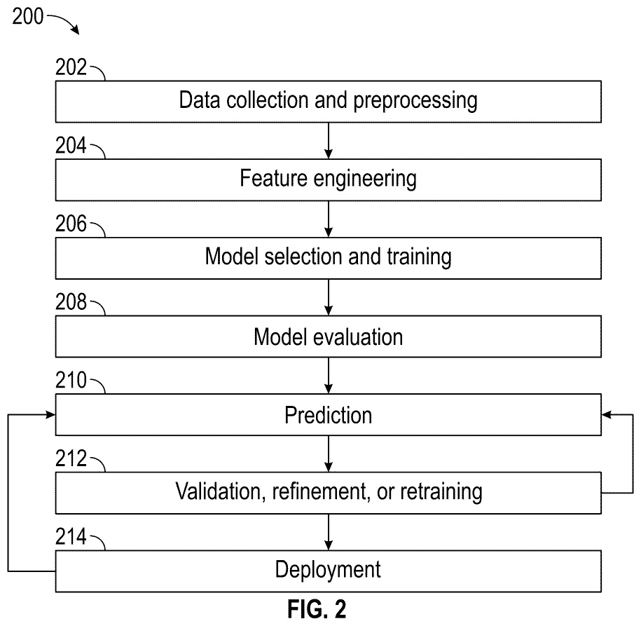

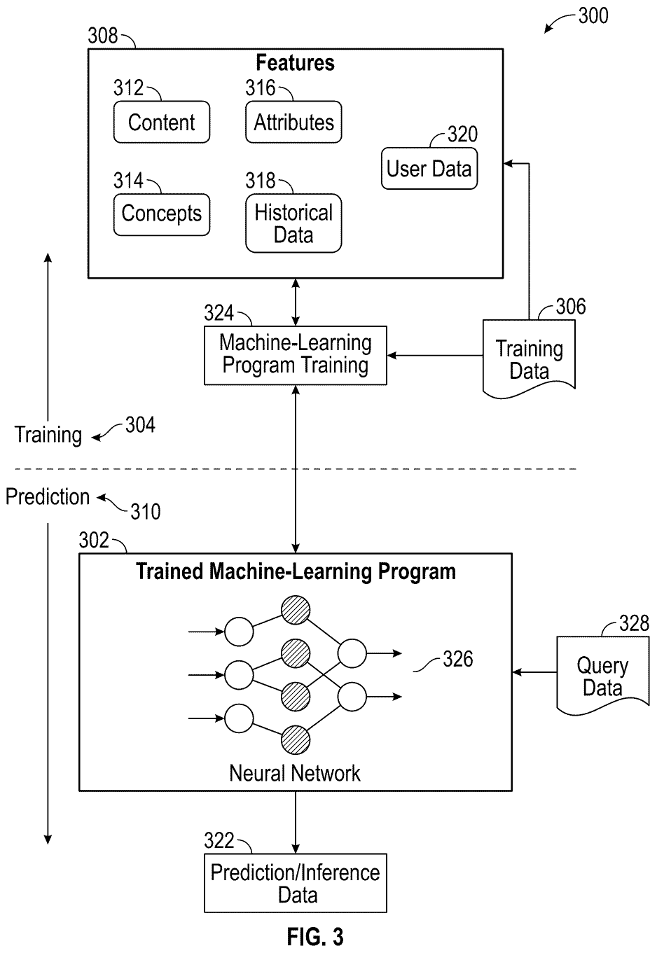

FIG. 2 depicts a machine-learning pipeline 200 and FIG. 3 illustrates training and use of a machine-learning program (e.g., model). Specifically, FIG. 2 is a flowchart depicting a machine-learning pipeline, according to some examples. The machine-learning pipeline 200 can be used to generate a trained model, for example the trained machine-learning program 302 of FIG. 3, to perform operations associated with automated identification, counting, size classification, weight ranking, and disease detection of harvestable food products such as sugar beets during real-time harvesting operations. The trained machine-learning program 302 processes image data captured by cameras integrated into harvesting equipment to recognize individual crops, distinguish crops from non-crop objects, assign crops to weight ranks based on visual characteristics, and detect visual indicators of disease conditions or quality defects.

Broadly, machine learning may involve using computer algorithms to automatically learn patterns and relationships in data, potentially without the need for explicit programming. Machine learning algorithms can be divided into three main categories: supervised learning, unsupervised learning, self-supervised learning, and reinforcement learning. In the context of the disclosed harvesting system, supervised learning techniques are primarily employed, wherein the machine learning models are trained on labeled datasets comprising images of harvestable food products with associated annotations identifying individual crops, their boundaries, their characteristics, and their conditions.

For example, supervised learning involves training a model using labeled data to predict an output for new, unseen inputs. In the disclosed harvesting system, supervised learning is used to train models to identify individual sugar beets in images captured during harvesting, to classify sugar beets into weight ranks based on visual size characteristics, and to detect diseases based on visual symptoms. The training process involves providing the model with many example images where the correct answers (e.g., beet locations, size classifications, disease status) are already known, allowing the model to learn the patterns and features that distinguish different classes and conditions. Examples of supervised learning algorithms that may be deployed include convolutional neural networks (CNNs) for image recognition tasks, region-based convolutional neural networks (R-CNN, Faster R-CNN, Mask R-CNN) for object detection and instance segmentation, and deep neural network architectures for multi-class classification of crop characteristics.

Examples of specific machine learning algorithms that may be deployed for sugar beet identification and characterization include convolutional neural networks (CNNs), which consist of interconnected layers of neurons that process visual information by learning hierarchical representations of image features. CNNs are particularly well-suited for image recognition tasks because they can automatically learn spatial hierarchies of features, from low-level edges and textures in early layers to high-level object representations in deeper layers. For crop identification tasks, CNNs learn to recognize visual features characteristic of sugar beets such as shape profiles (typically rounded to elongated root structures), color patterns (ranging from white to tan with various surface colorations), surface textures (smooth versus rough, clean versus soil-covered), size ranges, and distinguishing features that differentiate sugar beets from other objects in the harvester environment.

Object detection architectures such as YOLO (You Only Look Once), SSD (Single Shot MultiBox Detector), or region-based CNN variants may be employed to identify and localize multiple individual sugar beets within a single image frame captured during harvesting. These architectures output bounding boxes indicating the location and extent of each detected beet within the image, along with confidence scores indicating the probability that the detection represents an actual sugar beet rather than a false positive. Instance segmentation architectures may be employed to delineate the precise pixel-level boundaries of individual beets, enabling accurate separation of touching or overlapping beets and precise measurement of beet dimensions for size classification purposes.

For disease detection tasks, classification networks may be trained to categorize sugar beets into multiple disease classes based on visual symptoms observable in the captured images. The classification network learns to recognize visual patterns associated with specific disease conditions including: discoloration patterns characteristic of phytophthora root rot (darkening, water-soaked appearance), surface lesions and texture changes associated with black root rot, leaf spotting patterns visible on attached foliage indicating cercospora leaf spot, root surface deterioration and crown damage patterns indicative of Rhizoctonia root and crown rot, stunted or malformed root development suggesting Rhizomania infection, excessive lateral root development characteristic of sprangle condition, and other visual abnormalities indicating quality defects or pathological conditions.

The performance of machine learning models is typically evaluated on a separate test set of data that was not used during training to ensure that the model can generalize to new, unseen data. For the disclosed harvesting system, model performance is evaluated using metrics appropriate to each task: object detection accuracy measured by precision (percentage of detections that are true positives) and recall (percentage of actual beets that are detected), counting accuracy measured by comparing automated counts to manual ground-truth counts, size classification accuracy measured by correlation between visual rank assignments and actual measured weights, and disease detection accuracy measured by sensitivity (true positive rate) and specificity (true negative rate) compared to expert visual assessments or laboratory-confirmed diagnoses.

Although several specific examples of machine learning algorithms are discussed herein, the principles discussed herein can be applied to other machine learning algorithms as well. Deep learning algorithms such as convolutional neural networks, recurrent neural networks (for tracking beets across video frames), and transformers (for attention-based feature extraction), as well as more traditional machine learning algorithms like decision trees, random forests, and gradient boosting may be used in various aspects of the disclosed system including image preprocessing, feature extraction, classification, and post-processing of detection results.

Two example types of problems in machine learning are classification problems and regression problems. Classification problems, also referred to as categorization problems, aim at classifying items into one of several category values. In the disclosed system, classification tasks include: identifying whether an object in an image is a sugar beet or not (binary classification), classifying a beet into one of multiple weight rank categories (multi-class classification), and classifying a beet as diseased or healthy, or into specific disease categories (multi-class classification). Regression algorithms aim at quantifying some items (for example, by providing a value that is a real number). In the disclosed system, regression approaches may be used to predict continuous values such as estimated beet weight in pounds, estimated beet volume in cubic inches, or disease severity scores on continuous scales.

Turning to the training 304 phases as described and depicted in connection with FIG. 2, generating a trained machine-learning program 302 configured for sugar beet identification and characterization includes multiple phases that form part of the machine-learning pipeline 200, including for example the following phases illustrated in FIG. 2: data collection and pre-processing 202, feature engineering 304, model selection and training 206, model evaluation 208, prediction 210, validation, refinement, or retraining 212, and deployment 214, or a combination thereof.

Data collection and pre-processing 202 for training sugar beet identification models includes acquiring training data 306 comprising a plurality of images of sugar beets under various conditions representative of actual harvesting environments. The training data collection process includes: (1) capturing images of synthetic sugar beets, which are manufactured replicas or artificial representations of sugar beets created to provide consistent and controlled training samples with known characteristics; (2) capturing images of real sugar beets harvested under actual field conditions, including beets of various sizes, shapes, orientations, and cleanliness levels; (3) capturing images under diverse lighting conditions including natural daylight at different times of day, overcast conditions, and artificial illumination from harvester lighting systems; (4) capturing images of sugar beets in various states including freshly pulled with soil attached, partially cleaned, and fully cleaned after passing through cleaning mechanisms; (5) capturing images showing multiple beets in various spatial arrangements including isolated single beets, beets in single-file arrangements, touching or overlapping beets, and beets mixed with debris; and (6) capturing images of both healthy sugar beets and diseased sugar beets exhibiting visual symptoms of various pathological conditions.

The synthetic sugar beet images provide several advantages for training: they enable generation of large volumes of training data with precisely known ground-truth labels, they allow systematic variation of specific visual characteristics (size, shape, color, orientation) while controlling other variables, and they can be created in standardized conditions to establish baseline recognition capabilities before introducing the variability of real-world conditions. The real sugar beet images ensure that the trained model can handle the full complexity and variability encountered in actual harvesting operations.

The data pre-processing operations for sugar beet identification training include: cleaning the image data by removing corrupted or unusable images; normalizing image sizes, resolutions, and color spaces to ensure consistency; augmenting the training dataset through transformations including rotation, scaling, cropping, brightness adjustment, contrast adjustment, and adding noise to improve model robustness; and organizing the images into training sets, validation sets, and test sets with appropriate proportions (for example, 70% training, 15% validation, 15% testing).

The labeling process for training data 306 in sugar beet identification applications involves systematic annotation of the images to identify features 308 that the model must learn to recognize. For object detection and counting tasks, the labeling process includes: manually drawing bounding boxes around each individual sugar beet in the image; assigning each bounding box a class label indicating “sugar beet” to distinguish beets from background elements, debris, soil clumps, rocks, or harvester components; and annotating instances where beets are partially visible, occluded, or overlapping to teach the model to handle these challenging cases. For instance segmentation tasks, the labeling process may include: delineating pixel-level boundaries of individual beets to create segmentation masks; ensuring that touching or overlapping beets are labeled as distinct instances rather than merged objects; and marking regions of uncertainty where beet boundaries are ambiguous.

For size classification and weight ranking tasks, the labeling process includes: measuring or weighing actual sugar beets to determine their true weights; assigning each labeled beet to a weight rank within a predetermined range (such as ranks 1 through 10, where rank 1 represents the smallest/lightest beets and rank 10 represents the largest/heaviest beets) based on the measured weight; and correlating visual characteristics visible in the images (apparent size, dimensions, volume) with the assigned weight ranks to enable the model to learn the relationship between visual appearance and actual weight category.

For disease detection tasks, the labeling process includes: examining sugar beets to identify visual characteristics associated with disease conditions, either through expert visual assessment or through laboratory testing and subsequent imaging; annotating images to mark regions exhibiting disease symptoms such as discoloration, lesions, rot, malformation, or other pathological indicators; assigning disease classification labels indicating specific diseases including phytophthora root rot, black root rot, cercospora leaf spot, Rhizoctonia root and crown rot, Rhizomania, or other conditions; distinguishing between healthy beets and diseased beets to provide binary classification labels; and potentially assigning severity scores indicating the degree of disease progression. This labeling creates ground-truth annotations that teach the model to recognize the visual indicators of disease conditions that may be subtle or easily overlooked by untrained observers.

Feature engineering 304 for sugar beet identification involves selecting and transforming the training data 306 to create features 308 that are useful for predicting the target variables (beet presence, beet location, weight rank, disease status). In deep learning approaches using convolutional neural networks, much of the feature engineering occurs automatically within the network architecture, as the convolutional layers learn hierarchical representations of visual features. However, feature engineering may also include: preprocessing images to enhance contrast, reduce noise, or normalize color distributions; extracting hand-crafted features such as color histograms, texture descriptors, or shape features to supplement learned features; and designing network architectures with specific structural elements (such as attention mechanisms, multi-scale feature pyramids, or skip connections) that facilitate learning of relevant features for the specific tasks.

Model selection and training 206 for sugar beet identification includes selecting appropriate machine learning architectures and training them on the preprocessed and labeled training data 306. The model selection process considers factors including: the specific tasks to be performed (detection, counting, classification), the computational resources available for training and inference, the required inference speed to process images in real-time during harvesting, the accuracy requirements for each task, and the characteristics of the training data including dataset size, image quality, and label quality.

The training process for sugar beet identification models involves: initializing the neural network 326 with random weights or with pre-trained weights from models trained on large image datasets (transfer learning); feeding batches of training images through the network; computing loss functions that quantify the difference between the network's predictions and the ground-truth labels (for example, classification loss for disease detection, localization loss for bounding box predictions, segmentation loss for pixel-level masks); using backpropagation to compute gradients indicating how each network weight should be adjusted to reduce the loss; updating the network weights using optimization algorithms such as stochastic gradient descent, Adam, or other optimizers; and iterating this process for many epochs (complete passes through the training dataset) until the model converges to satisfactory performance.

For the multi-task nature of the disclosed system, the training process may employ multi-task learning approaches where a single neural network 326 is trained simultaneously on multiple related tasks (detection, counting, size classification, disease detection) by combining multiple loss functions. This approach enables the network to learn shared representations that benefit all tasks and improves efficiency compared to training separate models for each task.

During the training phase 304, hyperparameters are tuned to optimize model performance. Hyperparameters include: learning rate (controlling the size of weight updates), batch size (number of images processed together), network architecture parameters (number of layers, number of neurons per layer, types of layers), regularization parameters (controlling overfitting), data augmentation parameters (types and magnitudes of transformations applied), and training duration (number of epochs). Hyperparameter tuning may be performed using validation dataset performance, grid search, random search, or automated hyperparameter optimization methods.

Model evaluation 208 for sugar beet identification includes evaluating the performance of the trained machine-learning program 302 on separate test datasets that were not used during training or hyperparameter tuning. The evaluation metrics for detection and counting tasks include: precision (percentage of detected beets that are actual beets rather than false positives), recall (percentage of actual beets that are successfully detected), F1-score (harmonic mean of precision and recall), counting accuracy (percentage difference between automated counts and ground-truth manual counts), and mean average precision (mAP) across different confidence thresholds.

The evaluation metrics for size classification tasks include: classification accuracy (percentage of beets assigned to the correct weight rank), correlation coefficient between visual rank assignments and actual measured weights, and mean absolute error between predicted weights (calculated using visual ranks) and actual measured weights. The evaluation metrics for disease detection tasks include: sensitivity (true positive rate percentage of diseased beets correctly identified), specificity (true negative rate-percentage of healthy beets correctly identified as healthy), positive predictive value (percentage of beets identified as diseased that are actually diseased), and area under the receiver operating characteristic curve (ROC-AUC) measuring overall classification performance.

The model evaluation 208 phase also includes testing the trained model under conditions representative of actual deployment, including: processing images captured at harvesting speeds with motion blur and dynamic lighting; evaluating performance on beets of sizes, shapes, or disease presentations not well-represented in the training data to assess generalization; testing robustness to variations in camera position, angle, focus, and exposure; and evaluating real-time inference speed to ensure the model can process images fast enough for harvesting operations (typically requiring processing of multiple frames per second).

Validation, refinement, or retraining 212 for sugar beet identification models includes iterative improvement based on evaluation results and operational feedback. If evaluation reveals performance deficiencies in specific scenarios (for example, poor detection of small beets, confusion between certain disease types, or errors under specific lighting conditions), the training data 306 may be augmented with additional images representing those scenarios, the model architecture may be modified to better handle those cases, or the training process may be adjusted with different hyperparameters or loss function weightings. As the harvesting system is deployed and operates in actual field conditions, additional real-world image data with verified ground-truth labels (confirmed counts, measured weights, laboratory-confirmed disease diagnoses) can be incorporated into the training dataset, and the model can be retrained to improve performance based on this operational data. This creates a continuous improvement cycle where the model becomes progressively more accurate as it is exposed to diverse growing conditions, crop varieties, harvesting equipment configurations, and environmental conditions.

Deployment 214 of the trained machine-learning program 302 for sugar beet identification includes integrating the trained model into the harvesting system's computational hardware. The deployment process includes: optimizing the trained model for inference efficiency through techniques such as quantization (reducing numerical precision), pruning (removing unnecessary connections), or knowledge distillation (training smaller models to mimic larger models); converting the model to formats compatible with the deployment hardware, which may include edge computing devices, GPUs, or specialized AI accelerator hardware integrated into the harvester; implementing software interfaces that connect the model with camera data streams, GPS modules, load sensors, and sorting mechanism controllers; configuring the inference pipeline to process images in real-time, perform post-processing of detection results (such as non-maximum suppression to remove duplicate detections), and generate outputs in formats required by downstream systems (crop counts, weight ranks, disease flags, data records); and implementing monitoring systems that track model performance during actual operations and flag potential issues such as degraded accuracy or processing delays.

FIG. 3 illustrates further details of two example phases, namely a training 304 phase (e.g., part of the model selection and training 206) and a prediction 310 phase (part of 210). Prior to the training 304 phase, feature engineering 304 is used to identify features 308. For sugar beet identification applications, features 308 include visual characteristics such as: color features (RGB values, HSV representations, color histograms), texture features (edge patterns, surface roughness indicators, spatial frequency content), shape features (aspect ratios, circularity, convexity, boundary smoothness), size features (area in pixels, estimated dimensions, volume indicators), and contextual features (spatial relationships to other objects, position on conveyor, background characteristics). Each of these features may be a variable or attribute, such as an individual measurable property extracted from the image data.

In the training phase 304, the machine-learning pipeline 200 uses the training data 306 comprising labeled images of synthetic and real sugar beets to find correlations among the features 308 that enable accurate identification, counting, size classification, and disease detection. With the training data 306 and the identified features 308, the trained machine-learning program 302 is trained during the training phase 304 during machine-learning program training 324. The machine-learning program training 324 adjusts the weights within the neural network 326 to learn the relationships between visual features and the desired outputs (beet locations, weight ranks, disease classifications). The result of the training is the trained machine-learning program 302 (e.g., a trained or learned model) that can process new, unseen images of sugar beets captured during actual harvesting operations and accurately identify individual beets, generate counts, assign weight ranks, and detect diseases.

Further, the training phase 304 may involve machine learning, in which the training data 306 is structured (e.g., labeled during preprocessing operations with bounding boxes, class labels, weight ranks, disease annotations). The trained machine-learning program 302 implements a neural network 326 capable of performing classification (distinguishing beets from non-beets, classifying disease status), detection (localizing individual beets in images), instance segmentation (delineating beet boundaries), and regression (predicting continuous values such as estimated dimensions) operations. In some examples, the training 304 phase may involve deep learning with convolutional neural network architectures, where the network learns both low-level visual features (edges, textures, colors) and high-level semantic features (object-level representations of sugar beets and their characteristics) through its hierarchical layer structure.

In some examples, a neural network 326 is generated during the training phase 304 and implemented within the trained machine-learning program 302. For sugar beet identification, the neural network 326 may comprise convolutional layers that extract spatial features from images, pooling layers that reduce spatial dimensions while retaining important features, fully connected layers that perform high-level reasoning and classification, and specialized output layers appropriate to each task (such as bounding box regression layers for object detection, classification layers for disease detection, and regression layers for size estimation). The neural network 326 includes a hierarchical (e.g., layered) organization of neurons, with each layer consisting of multiple neurons or nodes. Neurons in the input layer receive the pixel values of the input images, while neurons in the output layer produce the final predictions (beet locations, classifications, weight ranks). Between the input and output layers, there may be many hidden layers, each consisting of multiple neurons that progressively extract more abstract and semantically meaningful representations of the image content.

In some examples, the neural network 326 may be one of several different types of neural networks suitable for computer vision tasks, such as a Convolutional Neural Network (CNN) for basic image classification, a Region-based CNN (R-CNN, Fast R-CNN, Faster R-CNN, Mask R-CNN) for object detection and instance segmentation, a YOLO (You Only Look Once) network for real-time object detection, a Single Shot MultiBox Detector (SSD) for efficient object detection, a Feature Pyramid Network (FPN) for multi-scale object detection, a U-Net for semantic segmentation, a ResNet (Residual Network) for deep feature extraction with skip connections, an EfficientNet for computationally efficient image recognition, or a Vision Transformer for attention-based image processing, merely for example.

In addition to the training phase 304, a validation phase is performed on the validation dataset to tune hyperparameters and monitor for overfitting. The validation dataset comprises images of sugar beets that were not included in the training set but are used during the training process to evaluate model performance on unseen data. The hyperparameters are adjusted based on validation performance to improve the model's accuracy, generalization, and robustness. Once a model is fully trained and validated, in a testing phase, the model is tested on a completely held-out test dataset comprising additional images of sugar beets that were not used during training or validation. The testing phase provides an unbiased assessment of the final model's performance on truly unseen data representative of actual deployment conditions.

In prediction 310 phase (also referred to as inference phase), the trained machine-learning program 302 uses the learned features 308 for analyzing query data 328 to generate predictions or inferences, as examples of prediction/inference data 322. For the disclosed harvesting system, during prediction 310 phase, the query data 328 comprises new images captured in real-time by cameras on the harvesting machine as sugar beets pass through the harvester. The trained machine-learning program 302 processes these images to generate prediction/inference data 322 comprising: identification of individual sugar beets in the images (for example, bounding boxes indicating beet locations), counts of the number of sugar beets detected in each image or passing through the system, weight rank assignments for each identified beet based on visual size characteristics, disease detection results indicating whether each beet exhibits signs of disease and which specific diseases may be present, and confidence scores indicating the model's certainty in each prediction.

The prediction/inference data 322 generated by the trained machine-learning program 302 is then used by other components of the harvesting system to: maintain accurate running counts of harvested beets, calculate predicted weights for individual beets by combining visual weight ranks with load sensor measurements through proration algorithms, trigger automated sorting mechanisms to divert diseased beets identified by the disease detection model, and create comprehensive data records for each individual beet including the model's outputs along with GPS coordinates, weight estimates, and timestamp information. The real-time nature of this prediction phase enables the harvesting system to make immediate operational decisions (such as activating sorting mechanisms) and to collect detailed per-beet data that would be impossible to obtain through manual observation or conventional sensing approaches.

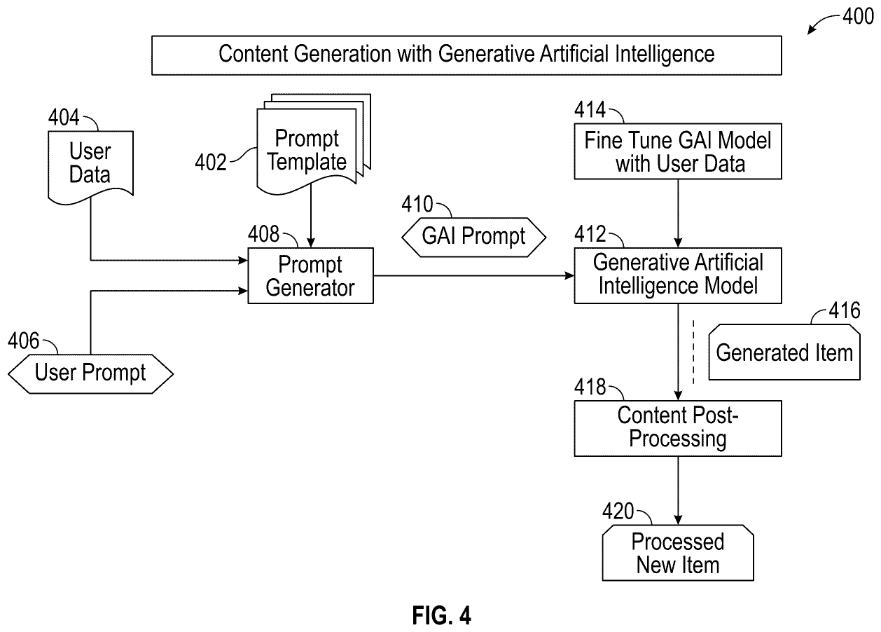

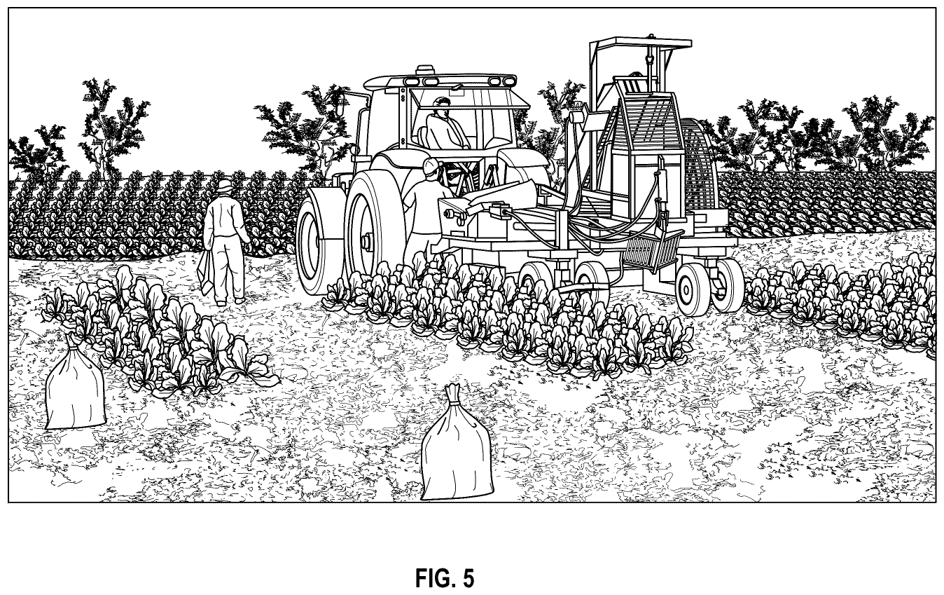

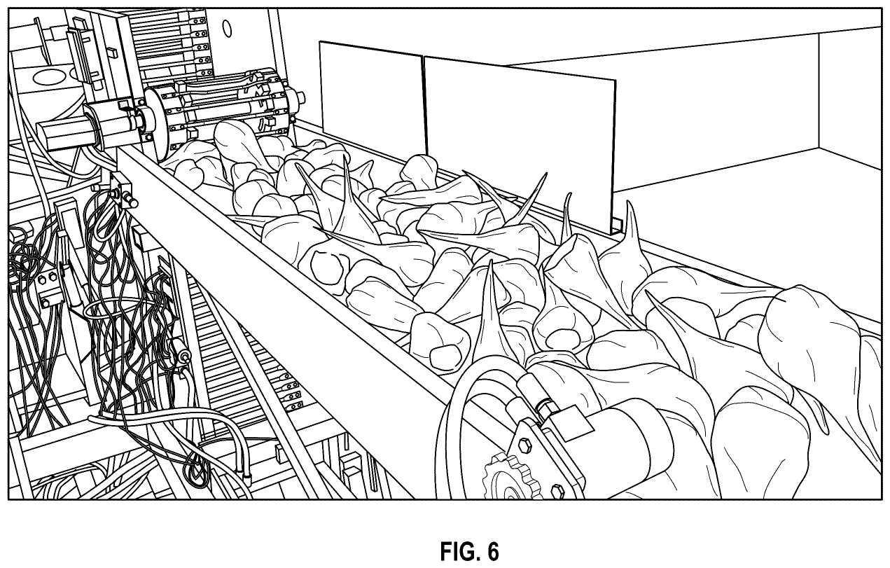

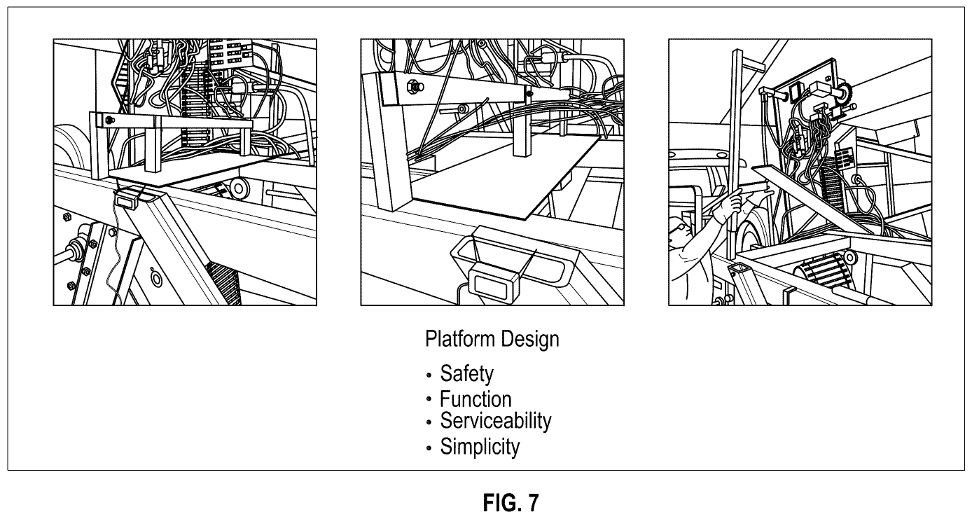

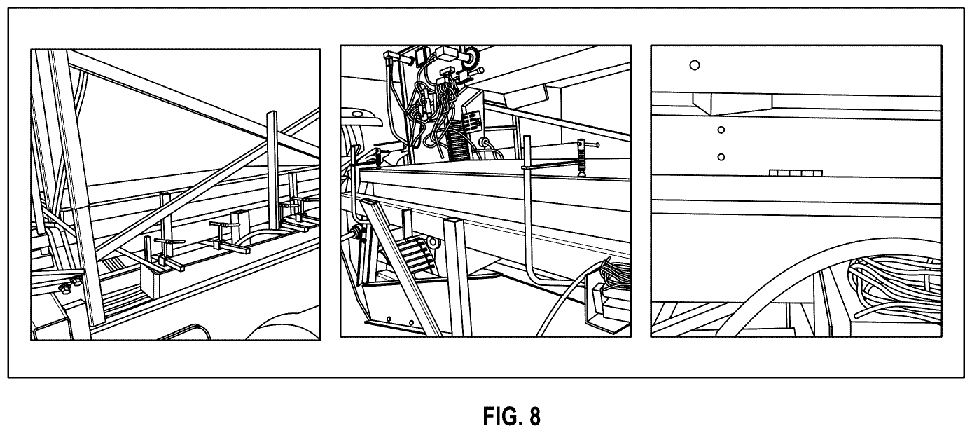

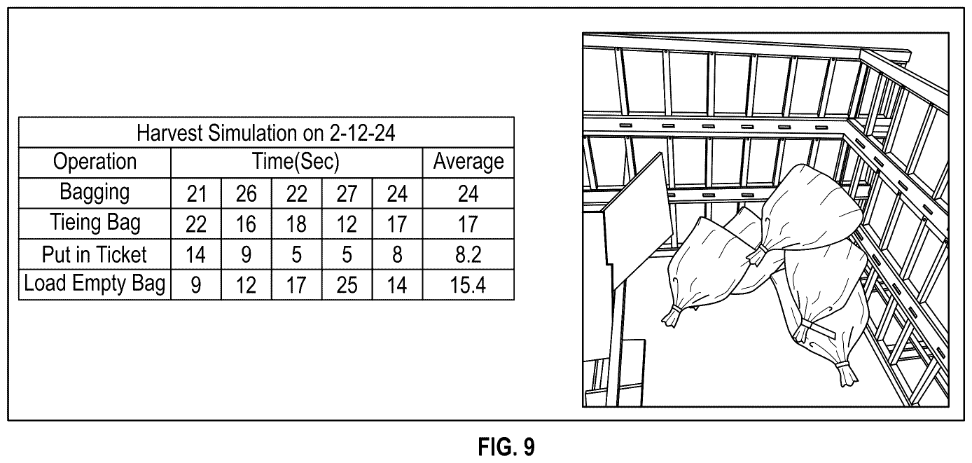

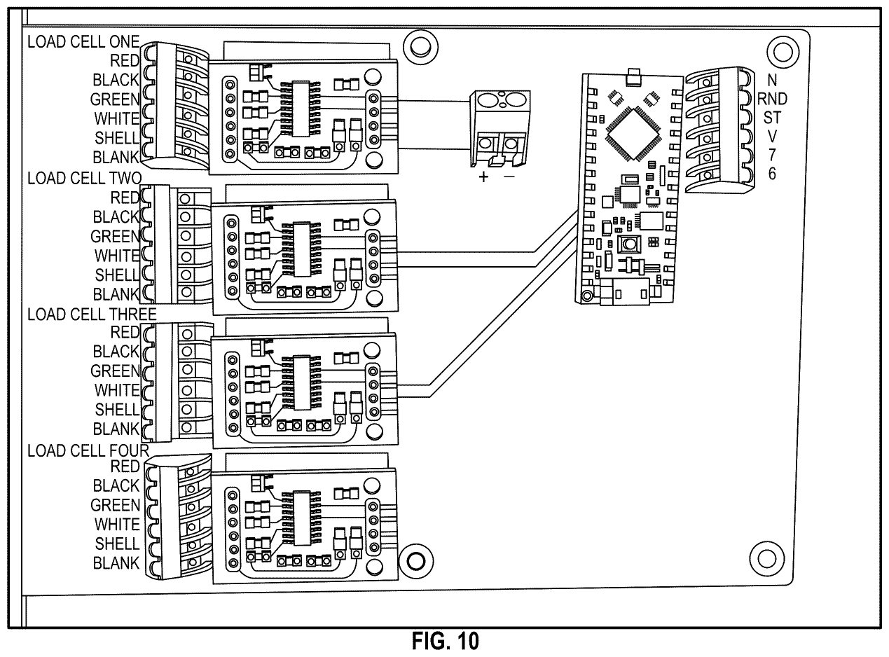

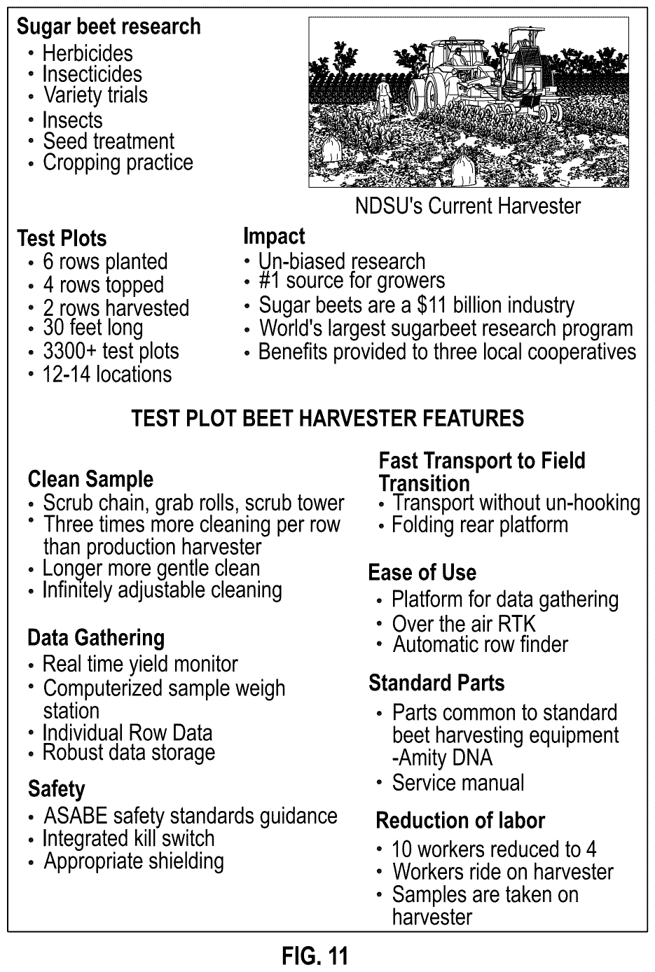

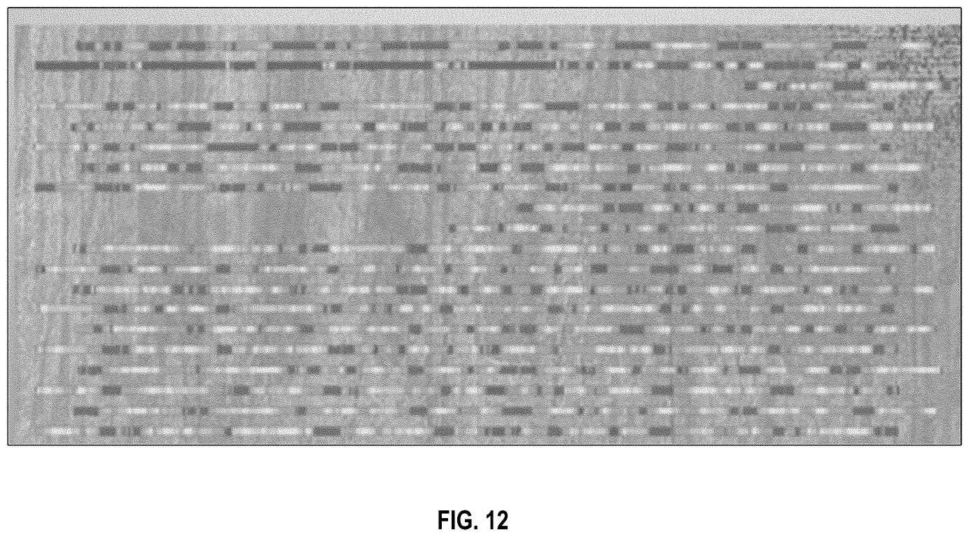

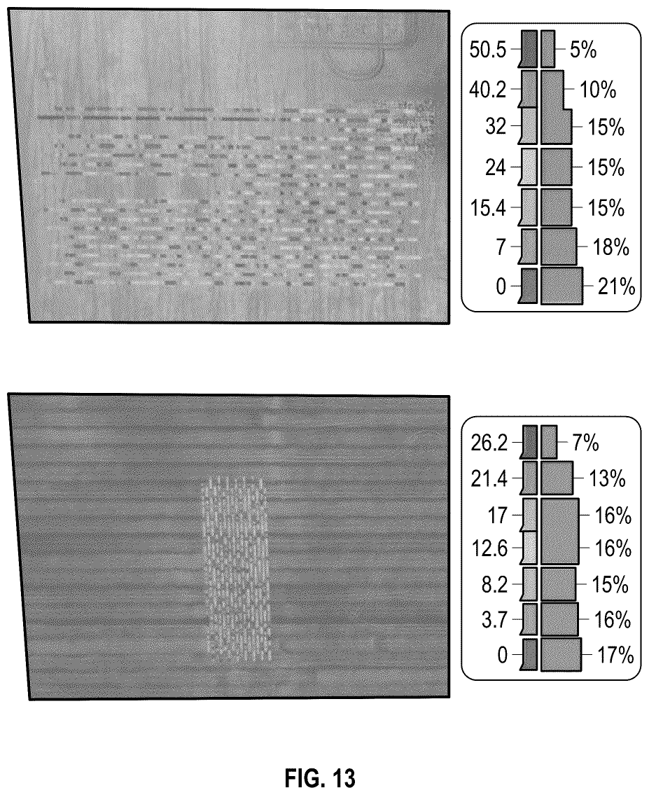

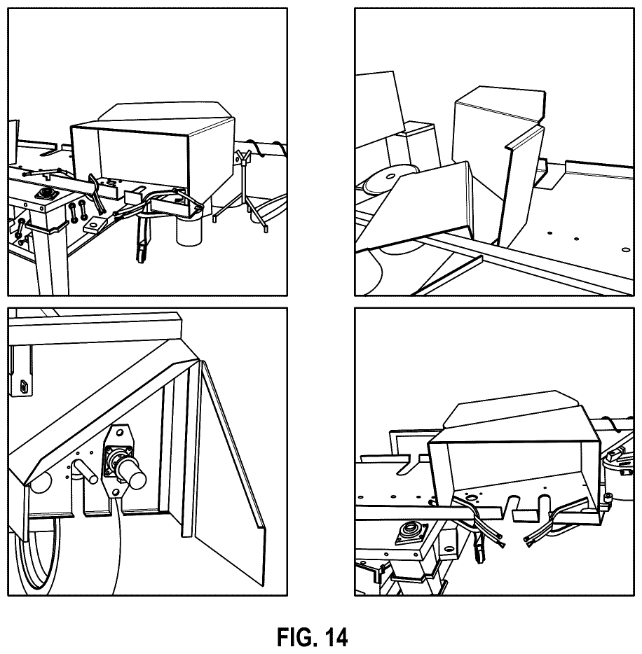

FIG. 4 illustrates a block diagram 400 employing the use of a Generative Artificial Intelligence (GAI) model 412 to generate new content, according to some examples. GAI is a type of AI that can generate new content, such as images, text, video, or audio. The GAI model 412 is trained on large datasets of data and uses this data to learn the patterns and relationships between different elements of the data. There are several types of GAI models, such as Generative Adversarial networks (GANs), Variational Autoencoders (VAEs), Autoregressive models, and more.

The GAI models generate items of different types, such as GAI models for creating text (e.g., GPT-4, Pathways Language Model 2 (PaLM 2), LaMDA), images (e.g., DALL-E 2, Stable Diffusion), videos (Runway Gen-2, Stable Diffusion Video), audio (e.g., Google MusicLM, Stable Audio), etc.

Often, the companies that create the GAI models make the GAI models available to users who can apply them to generate the desired content based on a GAI prompt 410 provided to the GAI model 412. Users can utilize the GAI model 412 as provided by the vendor or can optionally fine-tune 414 the GAI model 412 with their user data to adjust the parameters of the GAI model 412 in order to improve performance on a specific task or domain.

In some examples, fine-tuning the GAI model 412 includes the following operations: 1. Collect user data: Gather a collection of user data that is relevant to the target task or domain. This data could include text, images, audio, or other types of data; 2. Label the data: if the task requires supervised learning, the user data is labeled with the correct outputs; 3. Select a fine-tuning method. Some of the methods for fine-tuning GAI models include Full fine-tuning, Few-shot fine-tuning, and Prompt-based fine-tuning; 4. Train the GAI model 412: Perform incremental training of the tune 414 using the selected fine-tuning method; and 5. Optionally, evaluate the performance of the fine-tuned model on a held-out dataset.

The GAI model 412 can be used to generate new content based on the GAI prompt 410 used as input, and the GAI model 412 creates a newly generated item 416 as output.

The GAI prompt 410 is a piece of text or code that is used to instruct the GAI model 412 towards generating a desired output (e.g., generated item 416). The GAI prompt 410 provides context, instructions, and expectations for the output. The newly generated item 416 may be multi-modal, such as a piece of text, an image, a video, an audio, a piece of programming code, etc., or a combination thereof.

Prompt engineering is the process of designing and crafting prompts to effectively instruct and guide a GAI model toward generating desired outputs. It involves selecting and structuring the text that forms the GAI prompt 410 input to the GAI model 412, ensuring that the GAI prompt 410 accurately conveys the task, context, and desired style of the output.

A prompt generator 408 is a computer program that generates the GAI prompt 410. There are several ways to generate the GAI prompt 410. In one example, the prompt generator 408 may use a user prompt 406 entered by the user in plain language as the GAI prompt 410. In other examples, the prompt generator 408 creates the GAI prompt 410 without having a user prompt 406, such as by using a static pre-generated prompt based on the desired output.

In other examples, the prompt generator 408 uses a prompt template 402 to generate the GAI prompt 410. The prompt template 402 defines the structure of the GAI prompt 410 and may include fields that may be filled in based on available information to generate the GAI prompt, such as user data 404 or the user prompt 406. The prompt template may also include rules for the creating of the GAI prompt (e.g., include specific text when the recipient resides in California, but do not include the text if the recipient does not reside in California). In other examples, the prompt generator 408 uses heuristics codified into a computer program to generate the GAI prompt 410.

After the generated item 416 is generated, an optional operation of content postprocessing 418 may be performed to modify or block the newly generated item 416, resulting in a processed new item 420. The generated item 416 may be post-processed for various reasons, including improving accuracy and consistency (e.g., checking for factual errors, grammatical mistakes, or inconsistencies in style or format); enhancing quality and relevance (e.g., remove irrelevant or redundant content, improve coherence and flow, ensure that the output aligns with the intended purpose); enhancing output (e.g., polish wording, improve images, ensure that the style matches the desired effect); personalizing the new generated item 416; and ensuring ethical and responsible use.

The generated item 416 is new content, and it does not refer to content that is the result of editing or changing existing material (e.g., editing an image to include text within is not considered GAI-generated new content). One difference between the generated item 416 and material created with editing tools is that the newly generated item 416 is entirely new content, while the editing tool modifies existing content or creates the content one instruction at a time. Another difference is that the GAI model 412 can produce highly creative and imaginative content, while editing tools focus on enhancing the existing content based on user commands. Another difference is that the GAI model 412 can generate content rapidly, while the editing tools require more time and effort for thorough editing and refinement.

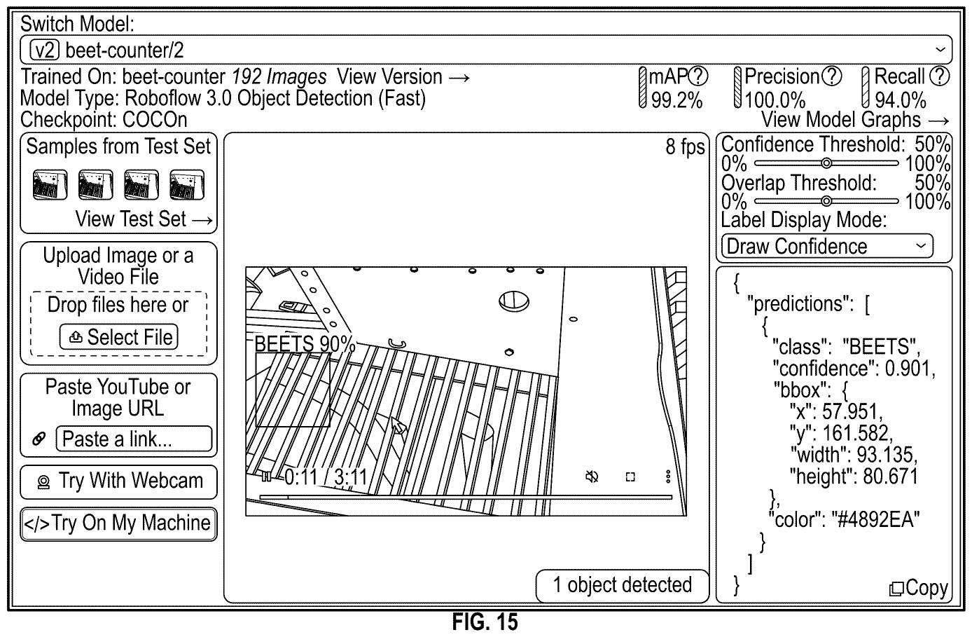

FIG. 15 includes a computer-implemented method for harvesting and analyzing harvestable food products includes performing real-time weighing of individual harvestable food products during harvest, tagging each harvestable food product with GPS location data, capturing 3D images of the harvestable food products, identifying and counting harvestable food products using AI-based image processing, detecting diseases using machine learning models, sorting diseased harvestable food products, integrating collected data points to create yield maps, and processing and storing the data in real-time.

Some embodiments relate to systems and methods for automated identification, counting, and data collection of crops using artificial intelligence and GPS integration. The system addresses limitations in traditional harvesting methods that rely on manual counting and outdated machinery.

Previous approaches to harvestable food product harvesting, such as sugar beet harvesting, have relied heavily on manual processes and basic mechanical systems. These traditional methods face several challenges:
Time-consuming manual counting and weighing
Prone to human error
Limited real-time data collection capabilities
Inability to detect diseases during harvest
Lack of precise location tracking for individual harvestable food products

Some embodiments provide an advanced harvesting system that integrates multiple technologies to overcome these limitations. The system includes:
1. Real-time Weighing System
   Performs live weighing of individual harvestable food products during harvest
   Uses weighing equipment integrated into conveyor belts
   Achieves accuracy within a quarter pound
2. GPS Location Tracking
   Tags each harvestable food product with precise GPS coordinates
   Maintains single-file alignment for accurate tracking
   Creates comprehensive yield maps
3. Imaging and Identification System
   Utilizes cameras with 3D dimensional understanding
   Captures high-resolution images of harvestable food products
   Employs machine learning algorithms trained on synthetic and real harvestable food products
   Performs real-time identification and counting
4. Disease Detection
   Uses machine learning models to identify diseases like phytophthora root rot and rhizomania
   Analyzes images in real-time
   Automatically sorts diseased harvestable food products to separate path
5. Data Integration and Processing
   Combines weight, location, size, and disease status data
   Creates comprehensive yield maps
   Processes and stores data in real-time
   Uses barcode system for sample tracking

The system is designed to handle approximately 400,000 harvestable food products from 3,400 test plots, processing two harvestable food products per second. The harvester includes:
Dual row capability
Selection table for checking and weighing
Cleaning chain system
Advanced Sorting Mechanisms

Some embodiments incorporate open-source software components enhanced with proprietary algorithms for improved performance. The system's accuracy and efficiency increase over time through machine learning optimization.

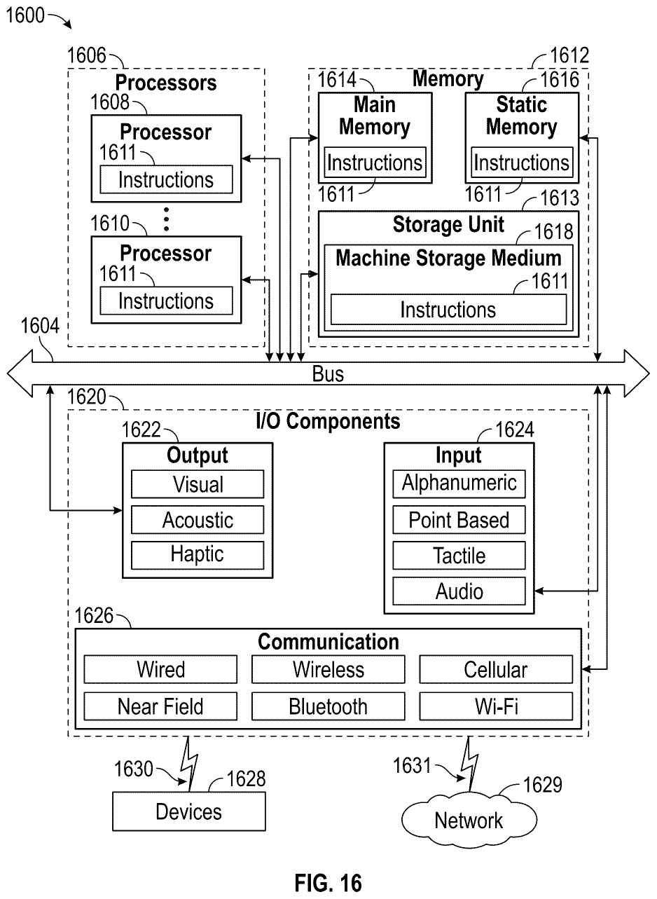

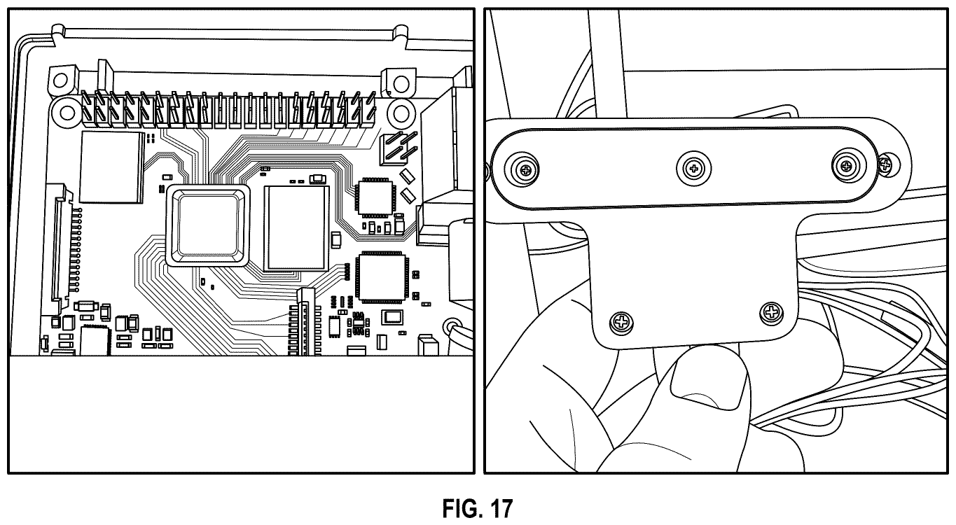

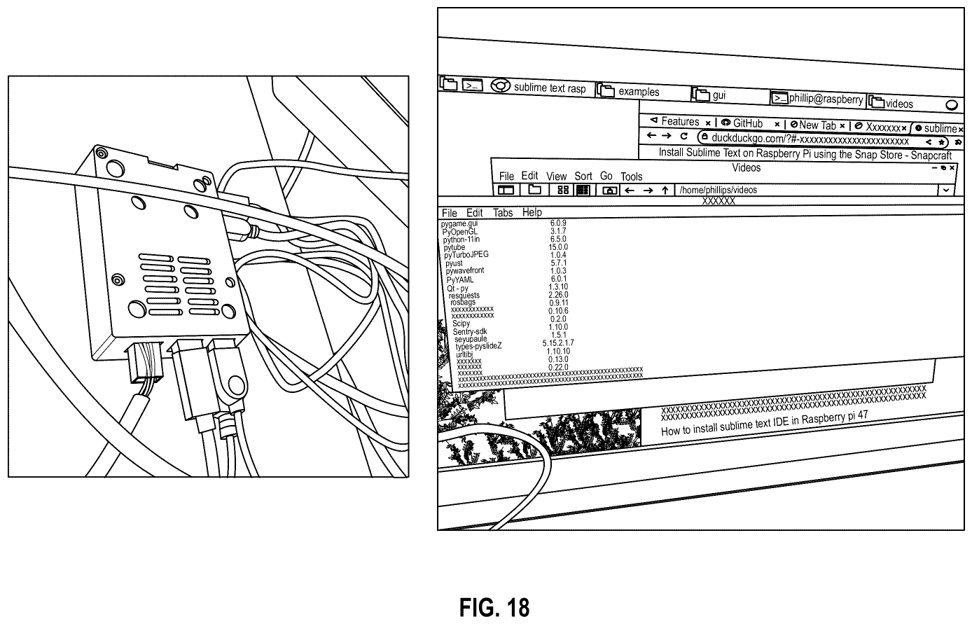

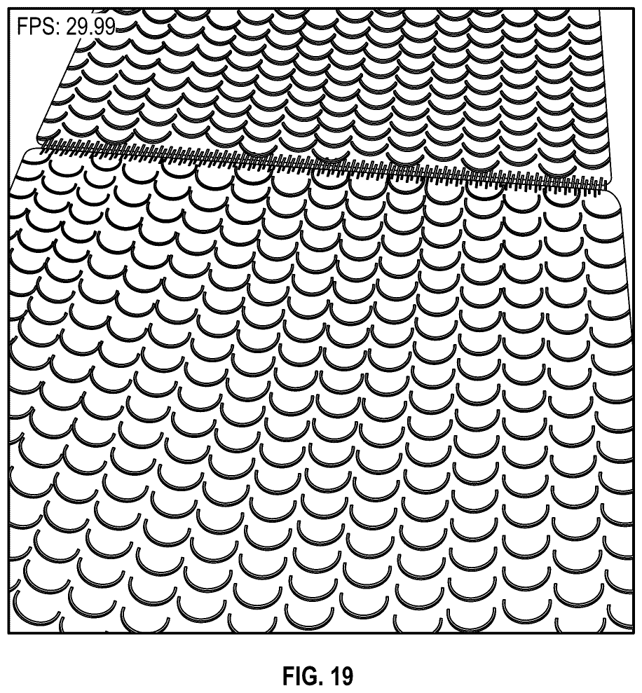

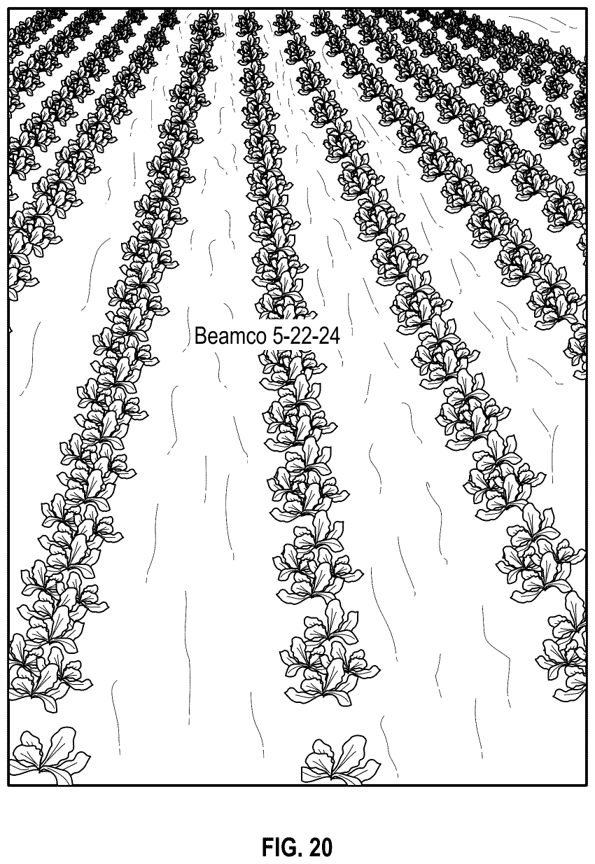

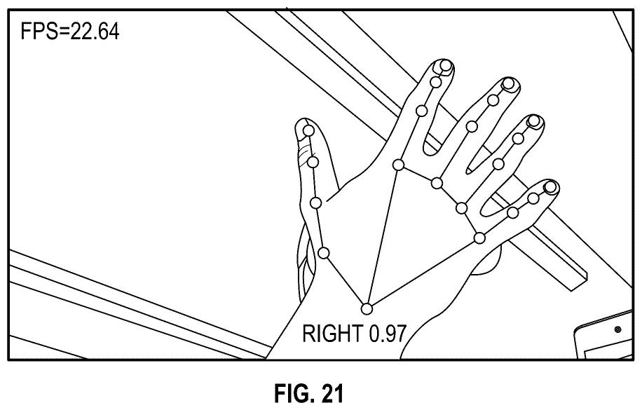

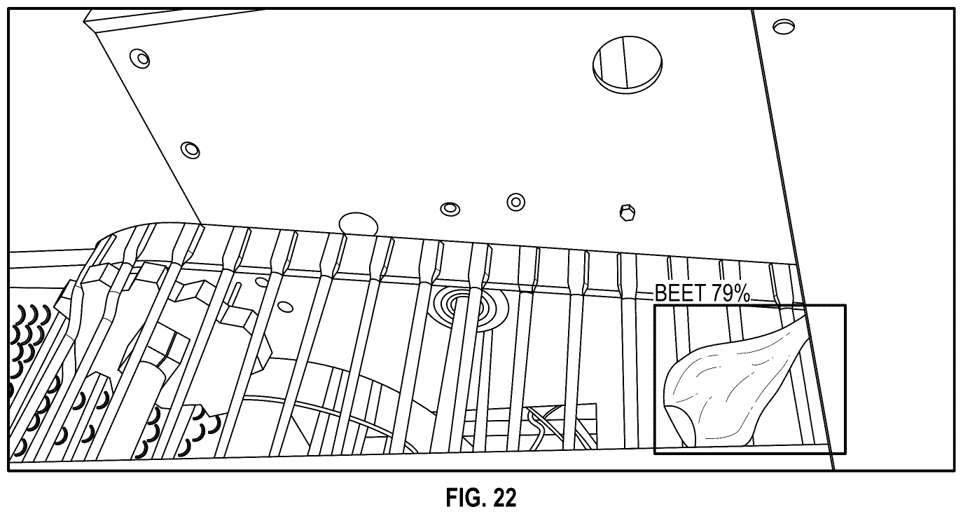

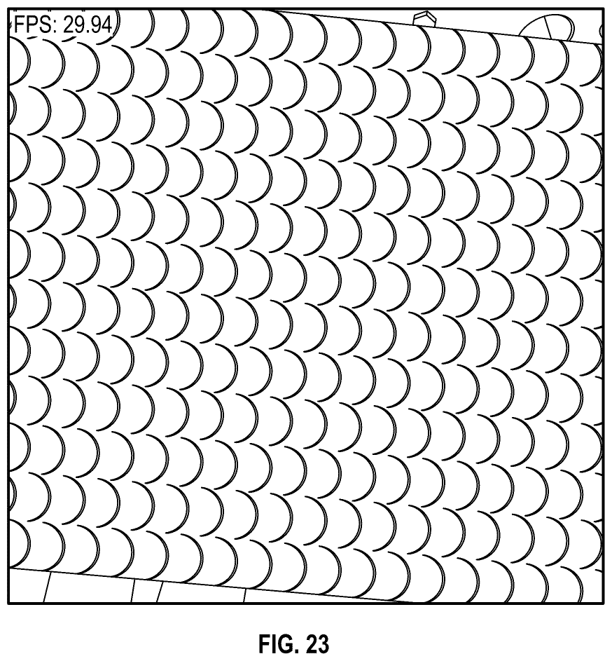

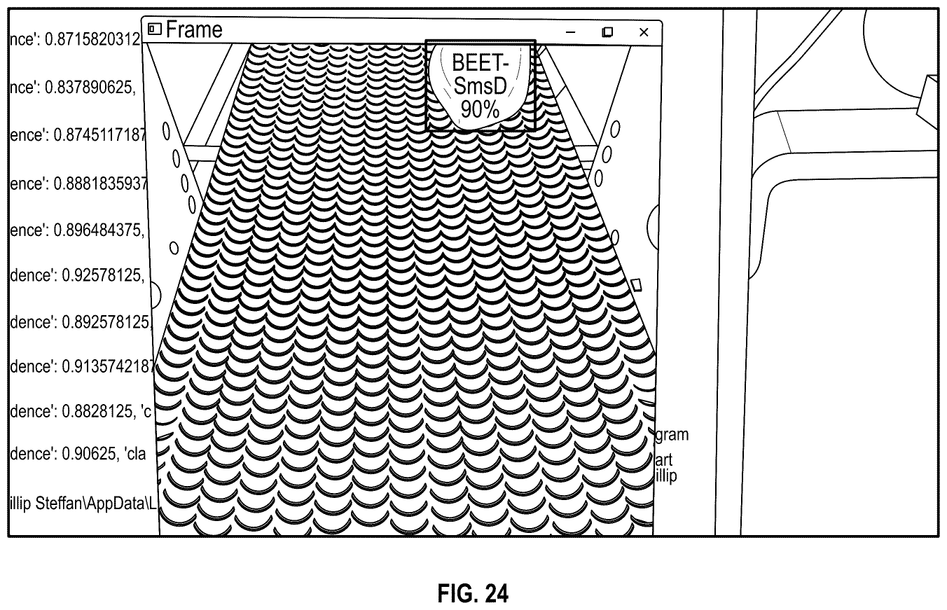

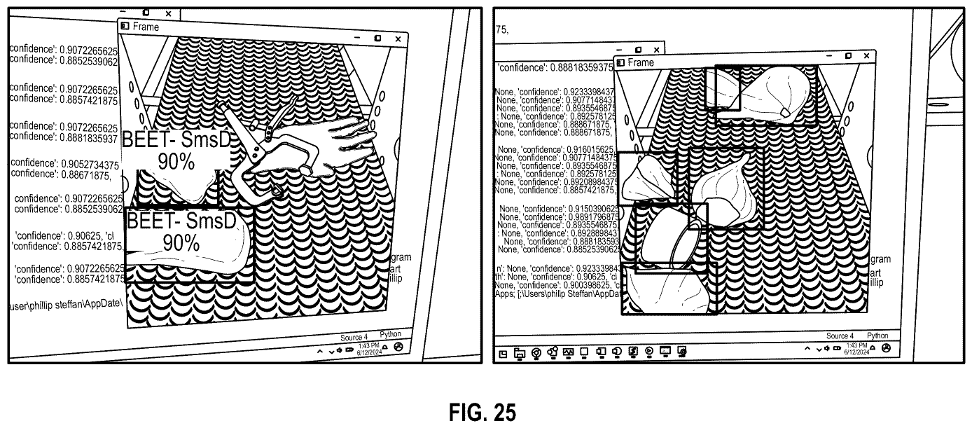

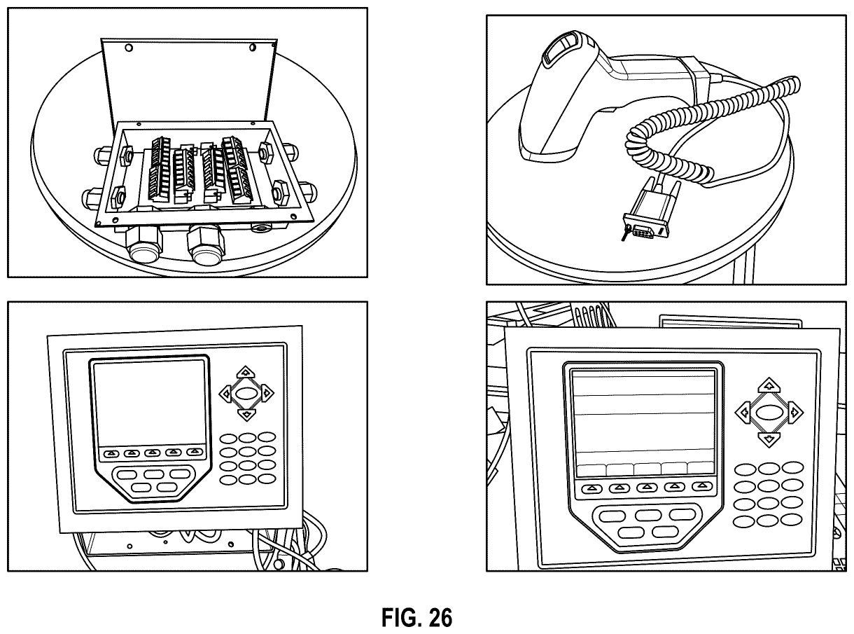

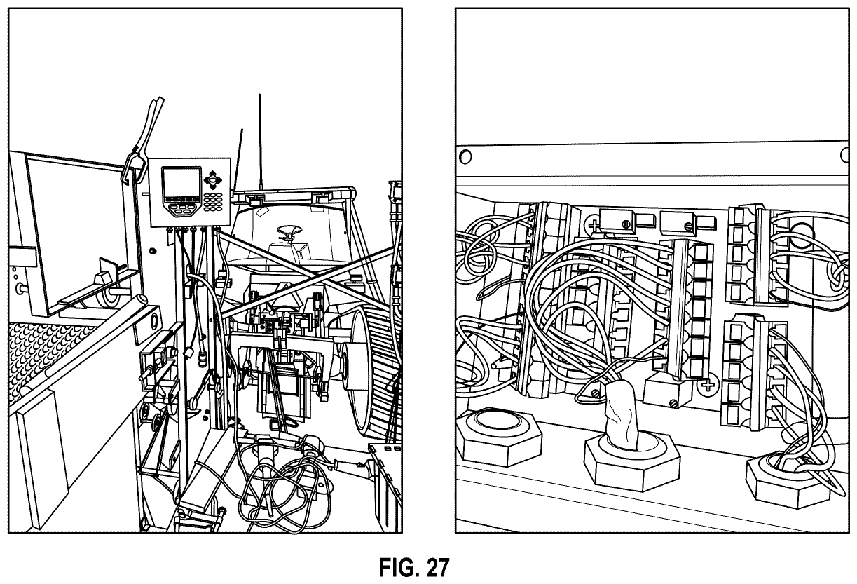

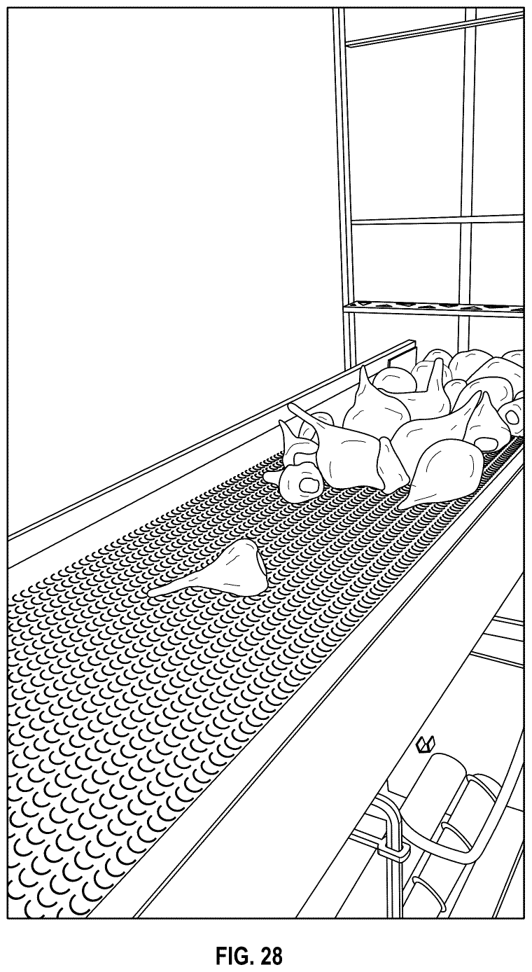

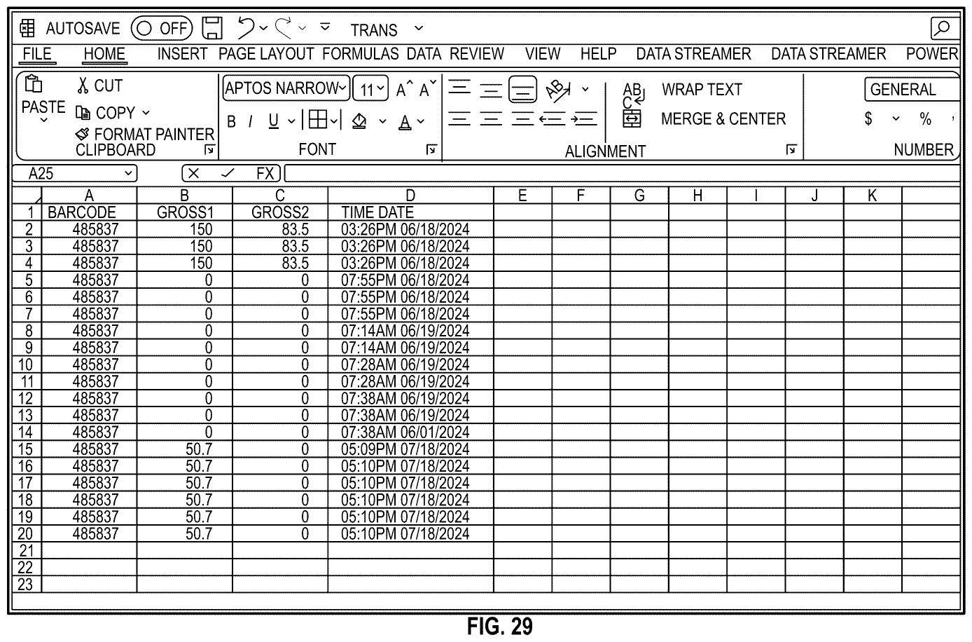

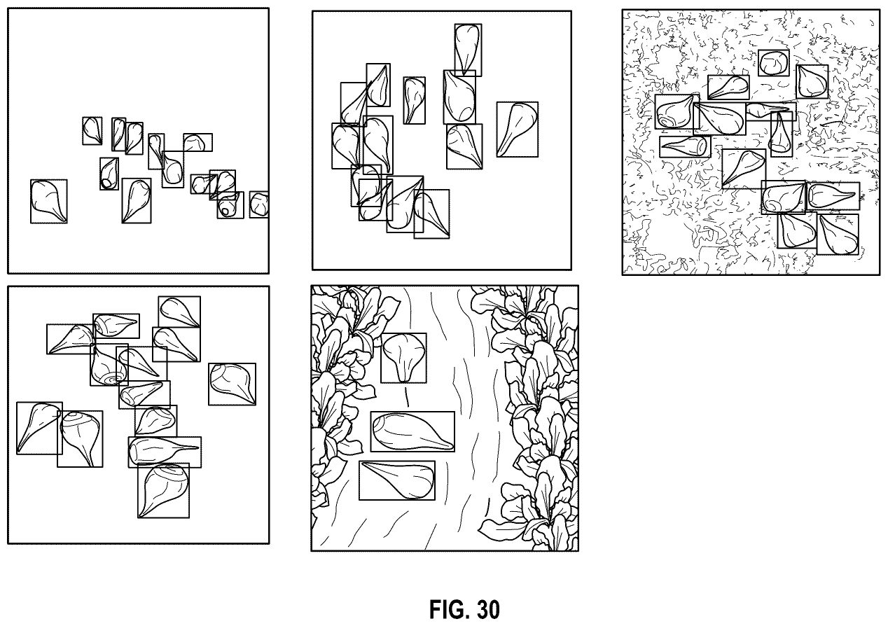

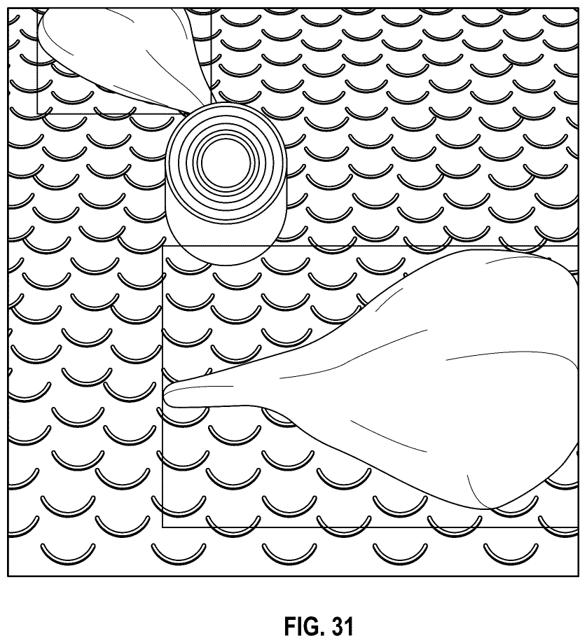

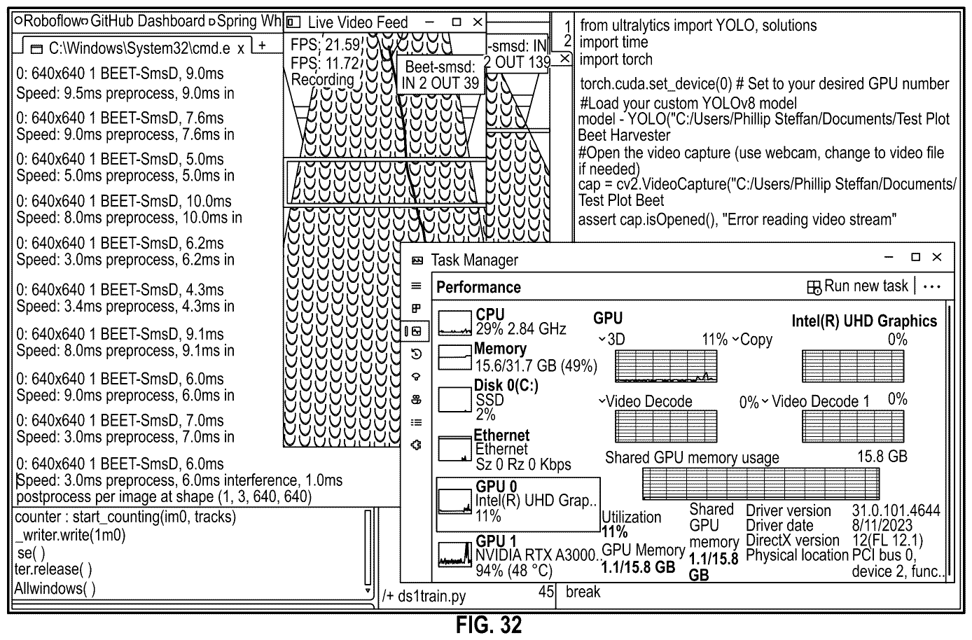

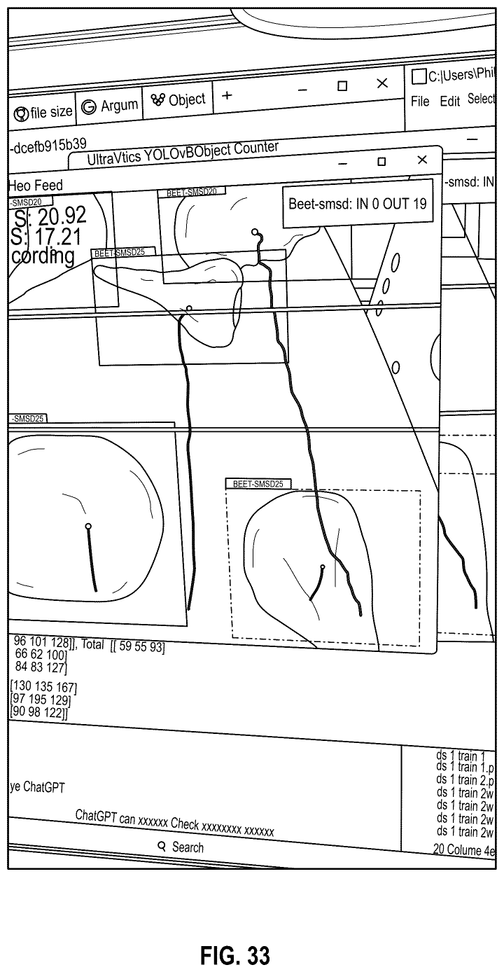

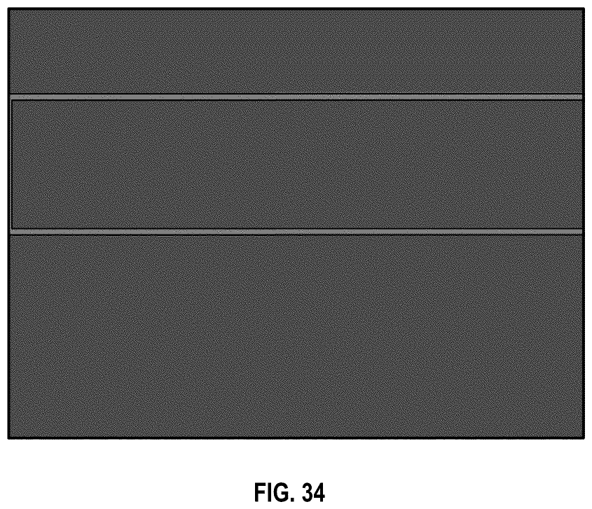

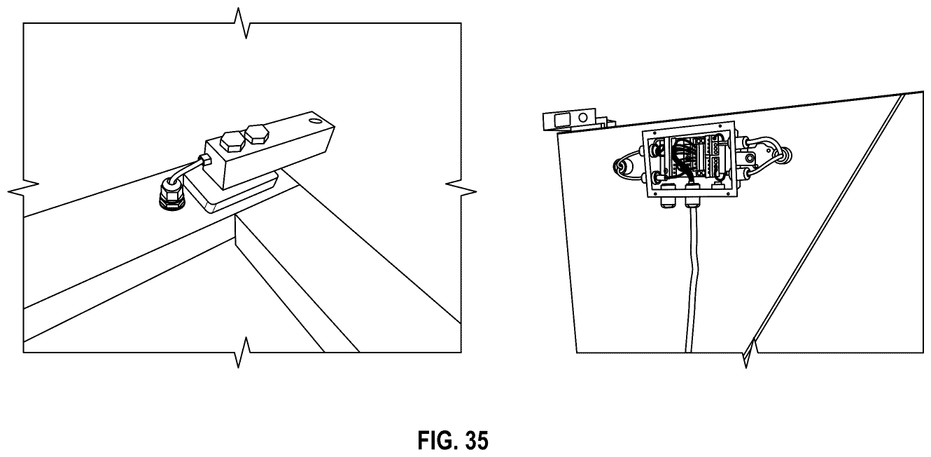

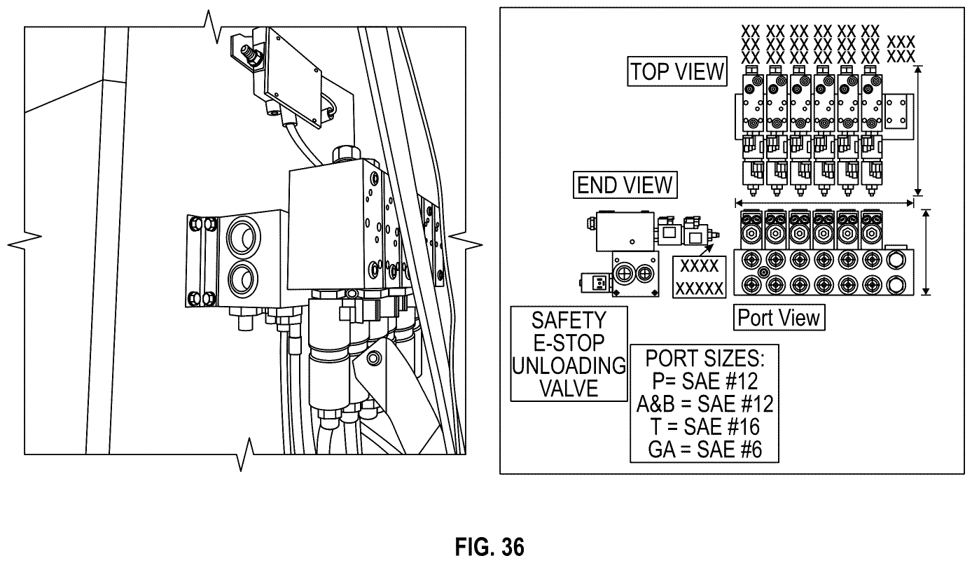

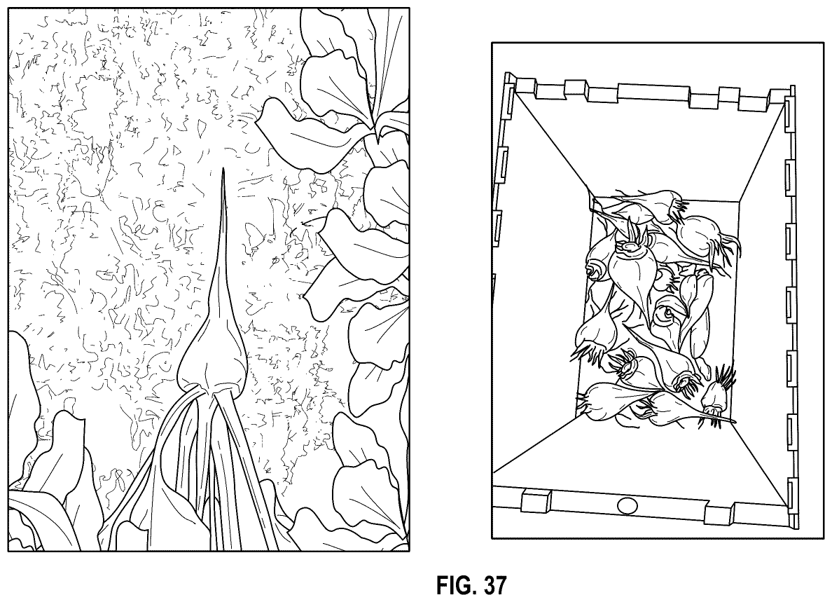

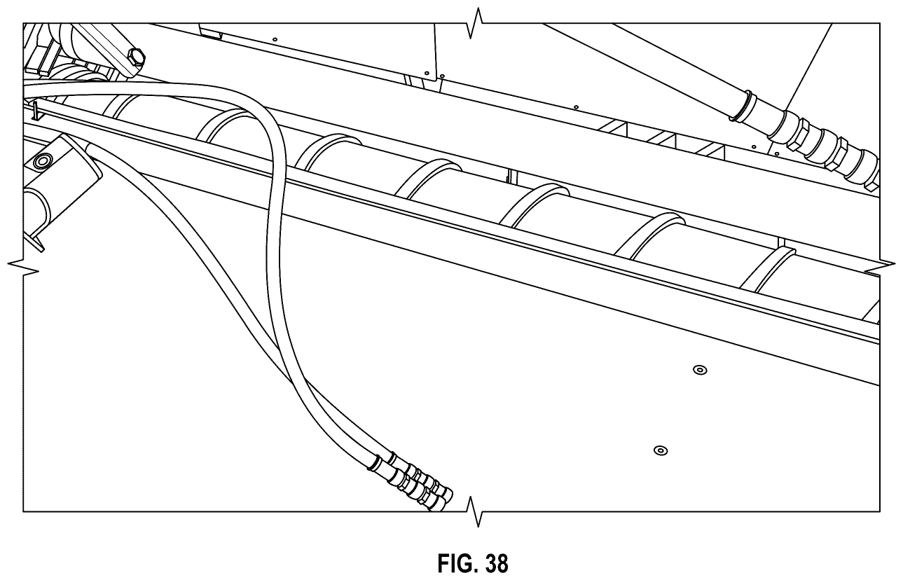

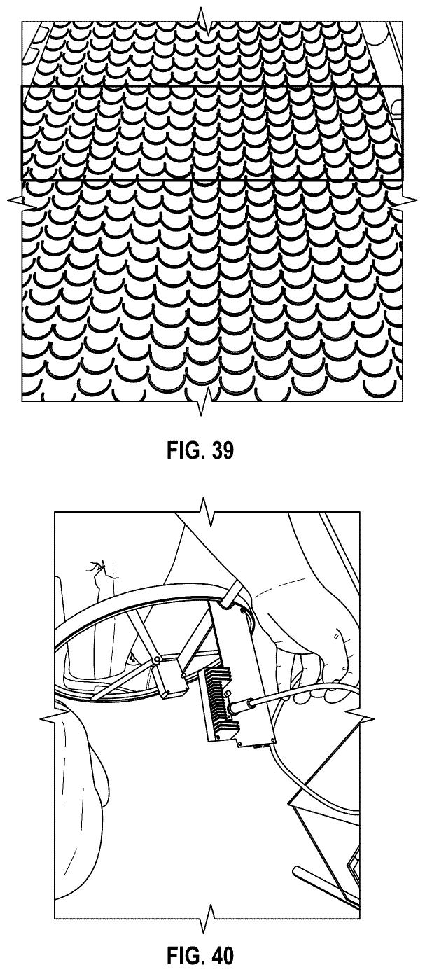

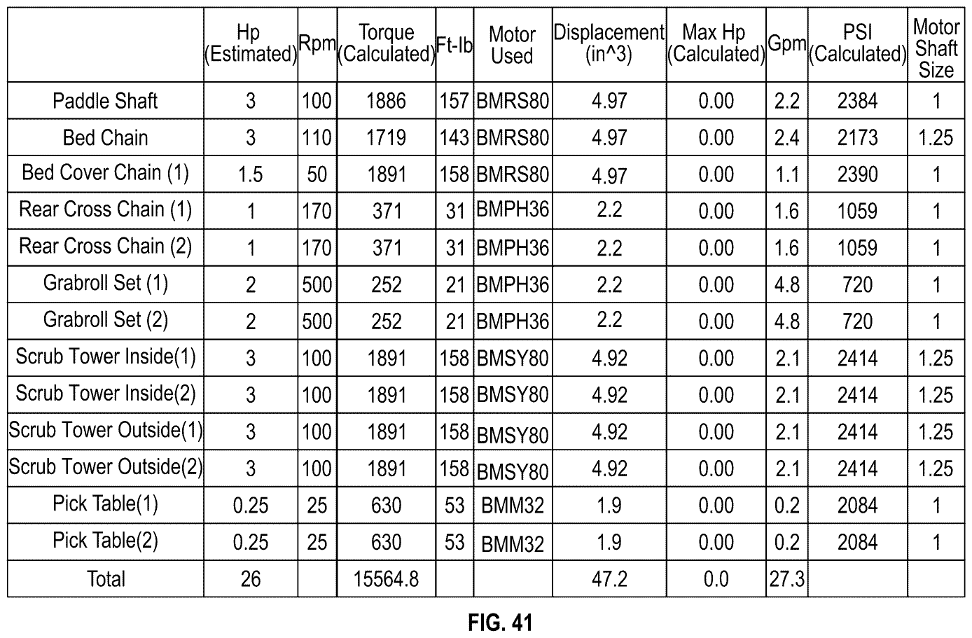

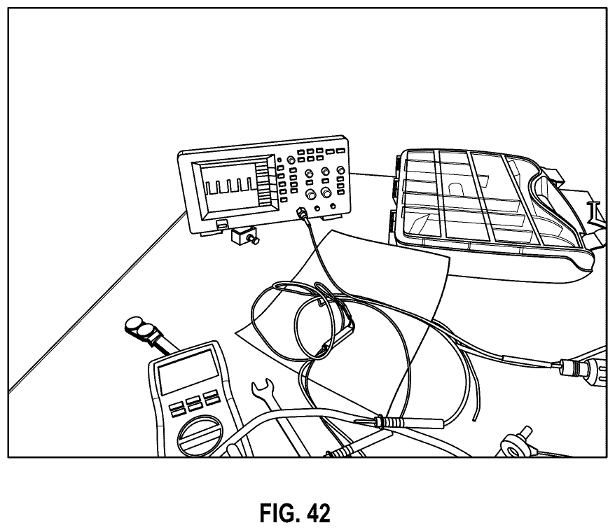

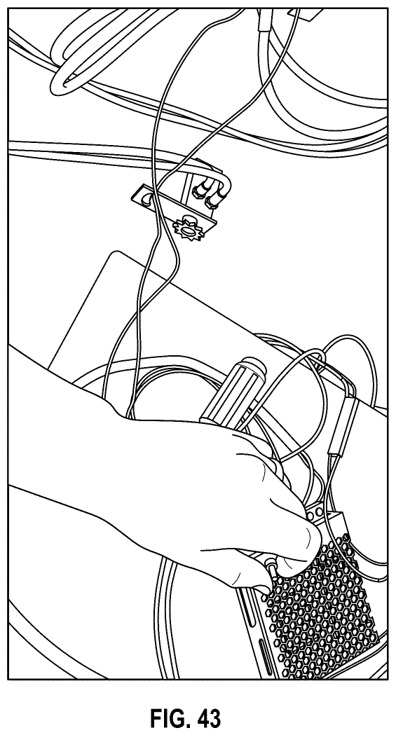

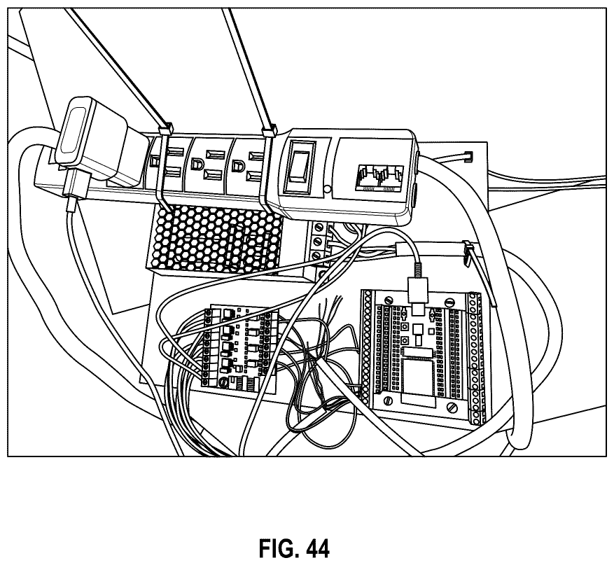

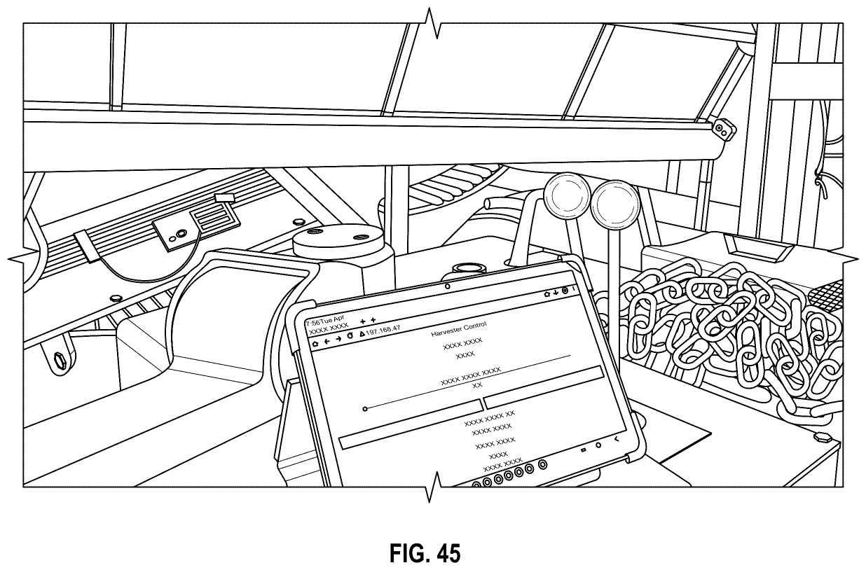

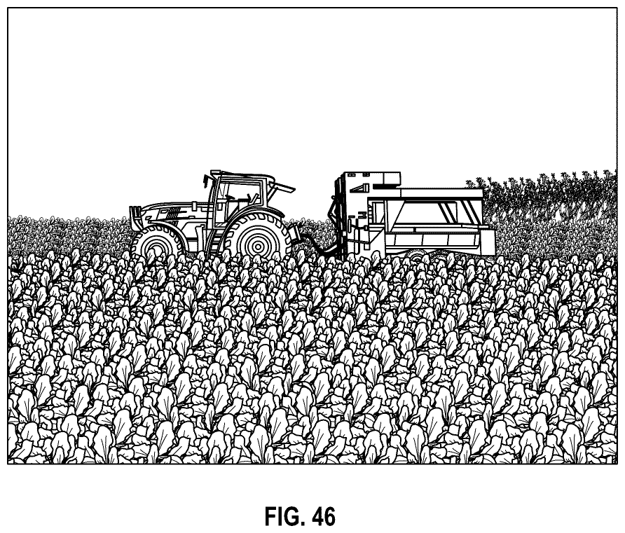

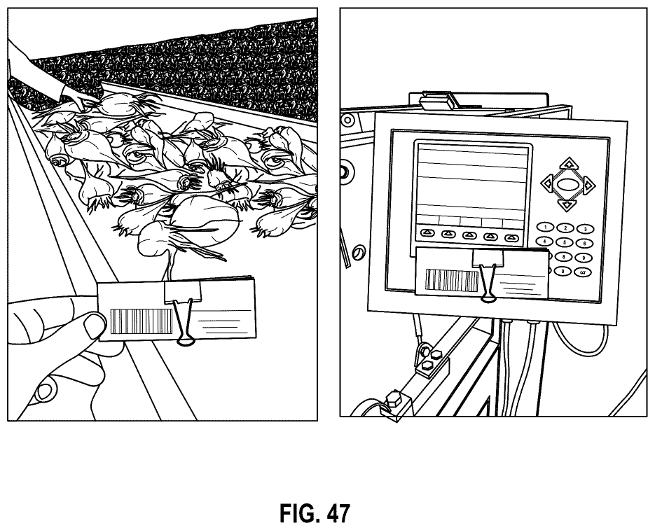

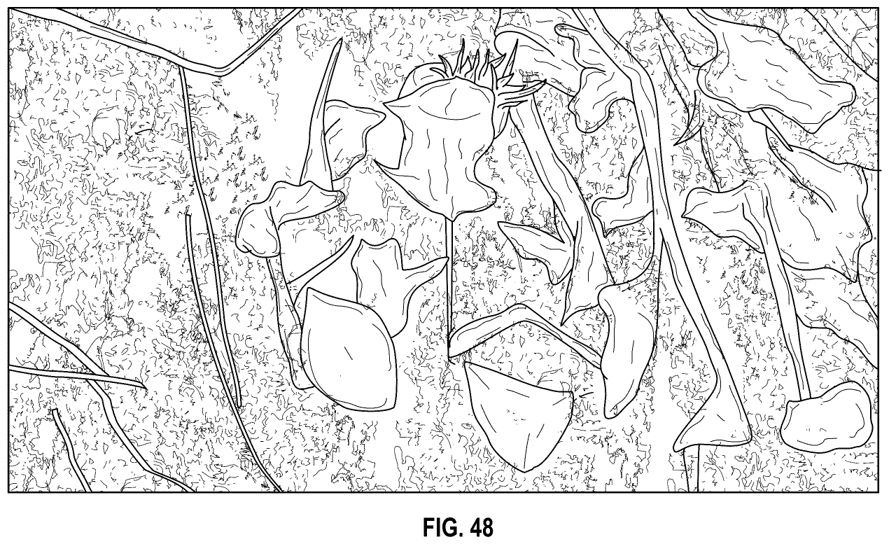

FIG. 16 illustrates a diagrammatic representation of a machine 1600 in the form of a computer system within which a set of instructions may be executed for causing the machine 1600 to perform any one or more of the methodologies discussed herein, according to an example embodiment. Specifically, FIG. 16 shows a diagrammatic representation of the machine 1600 in the example form of a computer system, within which instructions 1611 (e.g., software, a program, an application, an applet, an app, or other executable code), for causing the machine 1600 to perform any one or more of the methodologies discussed herein, may be executed. For example, the instructions 1611 may cause the machine 1600 to implement portions of the data flows described herein. In this way, the instructions 1611 transform a general, non-programmed machine into a particular machine 1600 that is specially configured to carry out any one of the described and illustrated functions in the manner described herein.

In alternative embodiments, the machine 1600 operates as a standalone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 1611, sequentially or otherwise, that specify actions to be taken by the machine 1600. Further, while only a single machine 1600 is illustrated, the term “machine” shall also be taken to include a collection of machines 1600 that individually or jointly execute the instructions 1611 to perform any one or more of the methodologies discussed herein.

The machine 1600 includes processors 1606, memory 1612, and input/output (I/O) components 1620 configured to communicate with each other such as via a bus 1604. In an example embodiment, the processors 1610 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), tensor processing unit (TPU), a radio-frequency integrated circuit (RFIC), another processor, or any suitable combination thereof) may include, for example, a processor 1608 and a processor 1610 that may execute the instructions 1611. The term “processor” is intended to include multi-core processors 1606 that may comprise two or more independent processors (sometimes referred to as “cores”) that may execute instructions 1611 contemporaneously. Although FIG. 16 shows multiple processors 1606, the machine 1600 may include a single processor with a single core, a single processor with multiple cores (e.g., a multi-core processor), multiple processors with a single core, multiple processors with multiple cores, or any combination thereof.

The memory 1612 may include a main memory 1614, a static memory 1616, and a storage unit 1613, all accessible to the processors 1606 such as via the bus 1604. The main memory 1614, the static memory 1616, and the storage unit 1613 comprise a machine storage medium 1618 that may store the instructions 1611 embodying any one or more of the methodologies or functions described herein. The instructions 1611 may also reside, completely or partially, within the main memory 1614, within the static memory 1616, within the storage unit 1613, within at least one of the processors 1606 (e.g., within the processor's cache memory), or any suitable combination thereof, during execution thereof by the machine 1600.

The I/O components 1620 include components to receive input, provide output, produce output, transmit information, exchange information, capture measurements, and so on. The specific I/O components 1620 that are included in a particular machine 1600 will depend on the type of machine. For example, portable machines, such as mobile phones, will likely include a touch input device or other such input mechanisms, while a headless server machine will likely not include such a touch input device. It will be appreciated that the I/O components 1620 may include many other components that are not shown in FIG. 16. The I/O components 1620 are grouped according to functionality merely for simplifying the following discussion and the grouping is in no way limiting. In various example embodiments, the I/O components 1620 may include output components 1622 and input components 1624. The output components 1622 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1624 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 1620 may include communication components 1626 operable to couple the machine 1600 to a network 1629 via a coupler 1631 or to devices 1628 via a coupling 1630. For example, the communication components 1626 may include a network interface component or another suitable device to interface with the network 1629. In further examples, the communication components 1626 may include wired communication components, wireless communication components, cellular communication components, and other communication components to provide communication via other modalities. The devices 1628 may be another machine or any of a wide variety of peripheral devices (e.g., a peripheral device coupled via a universal serial bus (USB)).

The various memories (e.g., 1612, 1614, 1616, and/or memory of the processor(s) 1606 and/or the storage unit 1613) may store one or more sets of instructions 1611 and data structures (e.g., software), embodying or utilized by any one or more of the methodologies or functions described herein. These instructions 1611, when executed by the processor(s) 1606, cause various operations to implement the disclosed embodiments.

Another general aspect is for a system that includes a memory comprising instructions and one or more computer processors or one or more hardware processors. The instructions, when executed by the one or more computer processors, cause the one or more computer processors to perform operations. In yet another general aspect, a tangible machine-readable storage medium (e.g., a non-transitory storage medium) includes instructions that, when executed by a machine, cause the machine to perform operations.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, (e.g., erasable programmable read-only memory (EPROM), electrically erasable programmable read-only memory (EEPROM), field-programmable gate arrays (FPGAs), and flash memory devices); magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1629 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1629 or a portion of the network 1629 may include a wireless or cellular network, and the coupling 1630 may be a Code Division Multiple Access (CDMA) connection, a Global System for Mobile communications (GSM) connection, or another type of cellular or wireless coupling. In this example, the coupling 1630 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1611 may be transmitted or received over the network 1629 using a transmission medium via a network interface device (e.g., a network interface component included in the communication components 1626) and utilizing any one of a number of well-known transfer protocols (e.g., hypertext transfer protocol (HTTP)). Similarly, the instructions 1611 may be transmitted or received using a transmission medium via the coupling 1630 (e.g., a peer-to-peer coupling) to the devices 1628. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1611 for execution by the machine 1600, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

In some example embodiments, computer-readable files come in several varieties, including unstructured files, semi-structured files, and structured files. These terms may mean different things to different people. Examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data.

As used herein, examples of unstructured files include image files, video files, PDFs, audio files, and the like; examples of semi-structured files include JavaScript Object Notation (JSON) files, eXtensible Markup Language (XML) files, and the like. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. The present example embodiments, as detailed herein, encompass various embodiments that have been provided for purposes of illustration and to furnish an exemplary framework for implementing the disclosed technology. It should be recognized by those skilled in the art that numerous modifications, variations, and alterations to the disclosed embodiments can be made without departing from the spirit and scope of the invention as set forth in the claims. The descriptions provided are not exhaustive and do not confine the invention to the precise forms disclosed. Rather, it is to be appreciated that all suitable modifications and equivalents which may be resorted to falling within the scope of the invention as defined by the claims that follow. The claims are to be accorded a broad range of interpretation so as to encompass all such modifications and equivalent structures and functions. This acknowledgment of the potential for alteration and modification by those of ordinary skill in the art is indicative of the inventiveness of the present disclosure, which should not be limited to the specific embodiments presented for illustrative purposes. Some embodiments are intended to cover various modifications and similar arrangements included within the spirit and scope of the appended claims, the legal equivalents of which are to be construed in light of existing and future technological developments. For example, while example embodiments include reference to search query results including enhanced document summarization, this is used by example and not limitation.

Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

What is claimed is:

1. A method of harvesting sugar beets, the method comprising:
operating a sugar beet harvesting machine configured to pull sugar beets from the ground and transport the sugar beets along a conveyor system;
capturing image data of the sugar beets on the conveyor system;
processing the image data using a pre-trained machine learning model to identify individual sugar beets in the image data;
generating a count of harvested sugar beets based on the identified individual sugar beets;
receiving a first signal from a load sensor associated with the conveyor system, wherein the first signal indicates a total weight of sugar beets on a first portion of the conveyor system;
determining a predicted weight for each individual sugar beet based on the count of harvested sugar beets and the first signal from the load sensor;
obtaining GPS data indicating a precise location where each individual sugar beet was pulled from the ground; and
creating a data record for each individual sugar beet, wherein each data record includes the predicted weight of the individual sugar beet and the GPS data indicating the precise location where the individual sugar beet was pulled from the ground.

2. The method of claim 1, wherein the sugar beet harvesting machine comprises a cleaning mechanism configured to separate soil from the sugar beets pulled from the ground, and wherein capturing the image data of the sugar beets on the conveyor system occurs after the sugar beets have passed through the cleaning mechanism and the soil has been separated from the sugar beets.

3. The method of claim 1, wherein determining the predicted weight for each individual sugar beet comprises:
processing the image data using the pre-trained machine learning model to assign each individual sugar beet to a weight rank within a predetermined range of weight ranks based on visual characteristics of the sugar beet;
receiving the first signal from the load sensor indicating a total weight measurement while the sugar beets are moving along the conveyor system; and
calculating the predicted weight for each individual sugar beet by prorating the total weight measurement from the first signal among the counted sugar beets based on their respective assigned weight ranks, wherein sugar beets assigned to higher weight ranks receive a proportionally greater allocation of the total weight than sugar beets assigned to lower weight ranks.

4. The method of claim 3, further comprising:
periodically stopping operation of the sugar beet harvesting machine;
receiving a second signal from a second load sensor associated with a second portion of the conveyor system while the sugar beet harvesting machine is stopped, wherein the second signal indicates an accurate total weight of a plurality of sugar beets positioned on the second portion of the conveyor system at rest;
comparing the accurate total weight indicated by the second signal to a sum of the predicted weights of the plurality of sugar beets calculated using the first signal; and
adjusting the predicted weight for each individual sugar beet of the plurality of sugar beets proportionally based on a difference between the accurate total weight indicated by the second signal and the sum of the predicted weights, wherein the adjusted predicted weights maintain the proportional weight relationships among the sugar beets based on their respective assigned weight ranks and sum to equal the accurate total weight indicated by the second signal.

5. The method of claim 1, wherein the pre-trained machine learning model is trained by:
collecting training data comprising a plurality of images of sugar beets, wherein the training data includes images of synthetic sugar beets and images of real sugar beets;
labeling the training data to identify individual sugar beets within the images;
training a machine learning algorithm on the labeled training data to recognize visual features characteristic of sugar beets; and
validating the trained machine learning model on a separate dataset to ensure accurate identification of sugar beets in real-time harvesting conditions.

6. The method of claim 1, wherein the pre-trained machine learning model is further trained to identify sugar beets exhibiting undesirable visual characteristics by:
collecting training data comprising images of diseased sugar beets and healthy sugar beets;
labeling the training data to identify visual characteristics associated with disease conditions in sugar beets; and
training the machine learning model on the labeled training data to detect visual indicators of disease conditions in sugar beets based on analysis of the captured image data.

7. The method of claim 6, wherein the disease conditions detectable by the pre-trained machine learning model include phytophthora root rot, black root rot, cercospora leaf spot, Rhizoctonia root and crown rot, and Rhizomania.

8. The method of claim 6, further comprising:
activating a sorting mechanism integrated into the sugar beet harvesting machine in response to detecting a sugar beet exhibiting the undesirable visual characteristics; and
directing the sugar beet exhibiting the undesirable visual characteristics to a separate path for disposal, storage, or further analysis, wherein the sorting mechanism prevents diseased sugar beets from being collected with healthy sugar beets.

9. The method of claim 1, wherein creating the data record for each individual sugar beet comprises:
storing in association with each individual sugar beet: (i) the GPS data indicating the precise location where the sugar beet was pulled from the ground, accurate to within one inch; (ii) the predicted weight of the sugar beet; (iii) a weight rank assigned to the sugar beet within the predetermined range of weight ranks based on visual characteristics; (iv) image data captured of the sugar beet; and (v) any detected disease status or undesirable visual characteristics identified by the pre-trained machine learning model;
wherein the data record enables analysis of relationships between sugar beet characteristics and field location.

10. The method of claim 9, further comprising:
analyzing the data records for a plurality of sugar beets harvested from a field to identify spatial patterns in sugar beet characteristics across the field;
generating a field map that visually represents the field divided into geographic zones based on the GPS data; and
displaying the field map with visual indicators representing aggregate characteristics of sugar beets harvested from each geographic zone, wherein the visual indicators comprise at least one of: color coding, shading, symbols, or numerical values that represent groupings of sugar beets by weight, size, disease prevalence, or other characteristics within each geographic zone, thereby enabling identification of field areas with specific yield or quality patterns.

11. The method of claim 1, further comprising:
capturing additional image data of the sugar beets using a second camera positioned to capture images of the sugar beets immediately after the sugar beets are pulled from the ground and before the sugar beets pass through a cleaning mechanism;
processing the additional image data to perform pre-counting of the sugar beets and to obtain more precise GPS location data for each sugar beet; and
using the additional image data in combination with the image data captured after cleaning to refine the predicted weight for each individual sugar beet.

12. A machine for harvesting root crops, the machine comprising:
a harvesting mechanism configured to extract root crops from soil;
one or more imaging devices mounted on the machine and configured to capture a plurality of images of individual root crops as the root crops are being harvested from the soil;
a processor operatively coupled to the one or more imaging devices and configured with a trained machine learning model to process the captured images to:
(i) identify and differentiate individual root crops within the captured images,
(ii) generate a count of the individual root crops, and
(iii) detect presence of disease conditions in the individual root crops based on visual characteristics;
a global positioning system operatively coupled to the processor and configured to determine, for each identified root crop, a geographic location using positioning data;
a data generation module operatively coupled to the processor and configured to generate, in real-time during the harvesting operations, crop data records that associate each identified root crop with its corresponding count data, disease detection data, and geographic location data;
a sorting mechanism integrated into the machine and configured to physically separate diseased root crops from healthy root crops;
a controller operatively coupled to the processor and the sorting mechanism, the controller configured to automatically control the sorting mechanism to separate the diseased root crops from the healthy root crops based on the disease detection data; and
a storage system operatively coupled to the data generation module and configured to store the crop data records in a database to create a spatially-referenced map correlating crop health status with geographic locations across a harvested field;
wherein the processor, the global positioning system, the data generation module, and the controller are configured to operate substantially contemporaneously with the extraction of the root crops from the soil by the harvesting mechanism.

13. The machine of claim 12, wherein the one or more imaging devices comprise three-dimensional imaging cameras, and wherein the processor is further configured to analyze dimensional characteristics of the individual root crops to determine size, shape, or volume measurements for each root crop.

14. The machine of claim 12, further comprising:
one or more weight sensors integrated into the machine and configured to measure a weight of each individual root crop; and
wherein the data generation module is further configured to associate the measured weight with the corresponding crop data record for each identified root crop, and wherein the crop data records further include weight data for generating spatially-referenced yield maps.

15. The machine of claim 12, wherein the processor is configured to detect presence of disease conditions by identifying visual indicators of at least one disease selected from the group consisting of: phytophthora root rot, rhizomania, fungal infections, bacterial infections, and pest damage.

16. The machine of claim 12, further comprising:
compositional analysis equipment integrated into the machine and configured to perform compositional analysis on a subset of the individual root crops during the harvesting operations to determine chemical composition characteristics;
an identifier assignment module configured to assign unique identifiers to individual root crops subjected to compositional analysis; and
wherein the data generation module is further configured to link the compositional analysis results to corresponding crop data records using the unique identifiers.

17. The machine of claim 12, further comprising:
a model updating module operatively coupled to the processor and configured to continuously update the trained machine learning model during the harvesting operations based on feedback data relating to accuracy of the disease detection; and
wherein the trained machine learning model is configured to improve detection performance over time through iterative learning from the feedback data.

18. The machine of claim 12, further comprising:
a spatial analysis module operatively coupled to the storage system and configured to:
(i) analyze the spatially-referenced map to identify geographic patterns correlating disease prevalence with specific locations within the harvested field, and
(ii) generate recommendations for targeted treatment of identified locations in subsequent growing seasons based on the identified geographic patterns.

19. The machine of claim 12, wherein the individual root crops comprise sugar beets, and further comprising:
a communication module operatively coupled to the data generation module and configured to:
(i) transmit the crop data records to a remote processing facility in real-time during the harvesting operations, and
(ii) receive adjusted harvesting parameters from the remote processing facility based on analysis of the transmitted crop data records; and
an adjustment module operatively coupled to the communication module and configured to modify operation of the machine based on the received adjusted harvesting parameters.

20. The machine of claim 12, wherein the trained machine learning model was trained prior to the harvesting operations using a supervised learning process comprising:
obtaining a training dataset comprising a plurality of labeled images of root crops, wherein the labeled images include:
images labeled as depicting healthy root crops, and
images labeled as depicting diseased root crops exhibiting one or more disease conditions;
training the machine learning model using the labeled images to learn visual characteristics that distinguish diseased root crops from healthy root crops; and
validating accuracy of the trained machine learning model in detecting disease conditions before deployment on the machine.

21. The machine of claim 20, wherein the training dataset comprises labeled images of both real root crops and synthetic root crops, and wherein the images labeled as depicting diseased root crops include labels identifying specific disease types selected from the group consisting of:
phytophthora root rot, rhizomania, fungal infections, bacterial infections, and pest damage.
